(19) United States
(12) Patent Application Publication
(10) Pub. No.: US 2003/0017843 A1
(43) Pub. Date: Jan. 23, 2003

(54) Method for multple use of a radiotelephone, and radiotelephone system corresponding subscriber identification module and presence detecting device

(76) Inventor: Gerard Noblins, Courbevoie (FR)

Correspondence Address: Westman Champlin & Kelly, Suite 1600 International Centre, 900 Second Avenue South, Minneapolis, MN, 55402-3319, US

(21) Appl. No.: 10/169,589

(22) PCT Filed: Dec. 27, 2000
(86) PCT No.: PCT/FR00/03704

(30) Foreign Application Priority Data
Jan. 6, 2000 (FR) 00/0208

(51) Int. Cl. H04Q 7/20; H04M 1/00; H04B 1/38; H04B 1/40

(52) U.S. Cl. 455/553; 455/426; 455/456; 455/74.1

(57) ABSTRACT

The invention concerns a method and a system for enabling multiple use of a radiotelephone, also called station, included in a radio communication system. The invention is characterised in that the station can adopt at least the following two operating states, each defined by at least one distinct state parameter: a so-called “mobile station” state, associated with a situation of geographical mobility of the station; and a so-called “fixed station” state, associated with a situation of geographical rigidity of the station within a predetermined fixed site, narrowly delimited in space. Moreover, the inventive method comprises at least a step which consists in a switching over the station, automatically or by user control, based on the presence of the station in a fixed site. The method further consists in at least comparing the position of the station relative to a predetermined fixed site, so as to trigger or validate said at least one state switchover step, if the station effectively shifts from inside outwards of the predetermined fixed site, or inversely.

Preamble

The purpose of this preamble is to set forth the line of thought which led the inventor to imagining the different methods claimed in this patent application. It deliberately simplifies the various options and variants in the hope of achieving better clarity.

Presence on the Access Market

Over the last century, traditional operators such as France Telecom or BT have developed a highly dense wire network reaching into every home and every workplace. This terminal network is called a local area network or local loop. It is essentially made up of copper pairs, 0.5 to 3 kilometers per subscriber. The cost of this kind of network is such that it is impossible for a new entry operator to make the investment needed to compete with the traditional operator on local access, except in some very dense business areas such as the La Defense close to Paris. There is therefore a risk that the traditional operators will hold a permanent de facto monopoly over the local loop.

To overcome this situation, market regulation authorities for telecommunications, such as ART in France, are considering allowing new entry operators to have access, on a hire basis, to the copper pairs owned by the traditional operator. This hire is called degrouping, a term which expresses the dividing of the traditional operator's network into different component parts, each one able to be hired out separately. Degrouping therefore concerns copper pair hire.

Degrouping is not a panacea for alternate operators; since to have access to the copper pair on the network side, it is necessary to develop a highly capillary architecture. Therefore, to cover France by means of degrouping, an alternate operator would have to deploy over 10 000 points of presence, which is extremely costly and time-consuming.

In recent years, new infrastructures have been deployed based on mobile networks. With their cover, they are able to reach most homes and businesses. Hence the idea of using these cell infrastructures (GSM, UMTS, etc) to offer customers local access as a substitute for wire access. The present invention comes within the scope of this context.

Fixed and Mobile Price Differences

There is one difficulty however. The prices of mobile services and fixed land services are and shall remain different, mobile prices being much higher than the latter owing to the heavy investment needed to build mobile networks, GSM firstly followed by UMTS. The simplest solution is to design equipment specifically for homes, that is the domestic station concept. This solution is expensive as it requires additional GSM equipment and is scarcely user-friendly since it does not offer continuity of terminal use for mobile application. Hence the idea of using one same mobile for both uses, fixed and mobile.

Different price rates therefore need to be determined for this mobile for those communications considered to come under local loop operation as they derive from a fixed place, and for those communications considered to concern mobile operation. In other words, a distinction must be made between communications entering and leaving a home and those made in a situation of mobility.

Fixed and Mobile Functioning of the Mobile Terminal

This leads to the idea of a complementary item of equipment that is not costly and is distributed with the mobile and located in the home or at the workplace which will hereinafter be called a presence detection device. Using an appropriate dialogue, it enables the mobile to recognize this device, subsequently to identify its location, and to change status changing over to local mode. This status change may assume various modalities described in the present invention. One of the essential modalities is the change in subscriber identifier (IMSI for GSM) within a SIM identification module, combined with a change in telephone number changing from a mobile MSISDN number using 06 09 68 to a fixed number also called the public switched network geographical number using 01 42 24 . . . .

In the remainder of this introduction, we shall use the GSM vocabulary to simplify the disclosure. The body of the claims is evidently wider.

It needs to be explained what this change in number involves. A mobile MSISDN number is by definition independent from a given location. Conversely, a geographical number carries within itself a place, an address and until recently it related to the endpoint of a copper line. In addition, calls from or to a mobile number come under different regulations and licences from those governing calls made from a geographical number, in particular in respect of interconnection prices and conditions. By changing IMSI and type of number, a mobile changes governing regulations and takes on the attributes of a fixed terminal which comes under local operator functioning. The invention also comprises an IMSI change with change in MISISDN number and no change in type of number.

One of the technical consequences of this approach using IMSI and number change is the invariance of the network and of the information systems (IS) for the method. The latter in fact only successively sees two different virtual terminals associated with separate offers, one fixed and the other mobile. No structural change to the network and the IS is required. No locating signal is needed. The method can be applied within a few weeks. It is also compatible with the sharing of common services by both virtual terminals, voice mail in particular.

The Local Device and its Direct Dialogue with a SIM Having Two IMSIs and Two Number Types

One of the chief modalities of the method therefore comprises an item of equipment at a fixed location, a dialogue between this equipment and the mobile and an IMSI-change functionality contained within the single SIM of the mobile. The most natural implementation of this dialogue is achieved by contact between the presence detection device and the mobile terminal. The mobile is therefore in contact, generally placed on the presence detection device, which may also serve as recharging base. As soon as contact is made, it switches over to fixed mode, answering to a geographical number.

This type of use is not very user-friendly, since it would be desirable for the user to be able to hold the mobile freely and use it in the usual manner. Hence the idea of using a timer system which would make it possible to remove the mobile from the device for a certain length of time, as laid down by the operator's marketing service, while maintaining the mobile in fixed mode.

This process has two drawbacks however, the first being the need to place the mobile down on the device after a certain length of time in order to maintain the fixed mode. The second is the specificity of the physical contact between the mobile and the present detection device, varying from one mobile supplier to another. It would therefore be necessary to develop as many devices as there are types of mobiles.

Dialogue without Direct Contact Between the SIM and the Presence Detection Device

This led to the idea of developing a direct SIM-Device dialogue, independent from the terminal and its connecting parts. Various application modalities of this direct dialogue are part of the invention, in particular “contactless” radio exchanges similar to those used for badge readers, and medium range radio exchanges. Both these processes assume the integration of an additional component in the SIM, which is possible with current technology.

Another approach is to use standardized means, Bluetooth in particular, for dialogue between mobiles and their local environment, even if the norm currently being developed needs to be modified to add profiles specific to this use. A last approach is to emulate, within the presence detection device, part of the radio behaviour of a base station (BTS) which would enable the mobile to recognize a home-associated “pseudo” cell.

The Irremovability and Limited Mobility of the Presence Detection Device

Finally the irremovable nature of the presence detection device needs to be assured once it has been installed at a location. The exact type of this irremovable nature may be modulated according to marketing needs. It is desirable that the device is able to be moved within a home. Local displacement, limited to a few meters therefore needs to be tolerated. Also, it must be possible for any displacement over a longer distance to be detected and either accepted or prevented as per marketing needs.

The method also deals with the acceptability of some major displacements, for holidays for example or stays in secondary homes. The maximum number of major displacements N is defined by marketing departments. The main point as far as the method is concerned is that it is possible to detect these displacements.

The anti-displacement mechanism is based on several distinct technological approaches. The first is only to cause the presence detection device to function when it is connected to the electricity or telephone network according to circumstances. The second approach consists of using an inertial device, of “tilt” type which detects a major displacement. The third consists of using information supplied by the mobile network, in particular the counting of crossed cells.

With the concomitant use of these techniques, it is possible to detect with almost definite certainty any displacement in the presence detection device. It would be difficult for a person with fraudulent intentions to displace the device by simulating an electricity supply, by preventing the functioning of the inertial device, and by limiting the number of cells perceived by the mobile. These three mechanisms are available with current technology and at low cost.

The method is based on a principle of relative locating and is therefore insensitive to reconfigurations of the mobile network that are fairly frequent. At the time of initialisation, the device is attached to a location and cannot be displaced without being reset. It may function without absolute locating, that is to say without involving permanent exchanges with the network, and without real time absolute precise calculations of mobile location. This is an important advantage for the method compared with other modes of location currently being developed, the GPS system firstly for which specific terminals and numerous calculations are needed and which does not function inside buildings, and secondly locating systems based on geographical coordinates of base stations (BTS) which lack precision in very dense or scarcely dense regions and are highly sensitive to any reconfiguration of the network, in particular the addition of new base stations.

### FIELD OF THE INVENTION

The field of the invention is the area of wireless communication systems. More precisely, the invention concerns the use of mobile stations within such systems. In the remainder of the description, mobile stations are also called cellular phones, or more simply stations.

The invention applies to any type of wireless communication system, in particular but not exclusively using the standards GSM (Global System for Mobile communications), DCS 1800 (Digital Cellular System 1800 MHz), PCS 1900 (Personal Communication System), DECT (Digital European Cordless Telecommunication) or UMTS (for Universal Mobile Telecommunication System).

Traditionally, in most wireless communication systems, a cellular phone (or MS for Mobile Station to use GSM terminology) comprises a terminal (or ME for Mobile Equipment according to GSM terminology) cooperating with a subscriber identification module (or SIM card standing for “Subscriber Identity Module” in GSM terminology, or DAM for “DECT Authentication Module” in DECT terminology). Alternately, a cellular telephone is at times only made up of the terminal and therefore does not comprise a subscriber identification module. Generally, the invention applies irrespective of cellular phone type (with or without subscriber identification module).

Traditionally, a distinction is made between the two following types of telephony: fixed telephony, on the public switched telephone network (PSTN), and mobile telephony on wireless communication networks (cell networks for example). In respect of mobile telephony, there are currently three cell telephony operators in France (SFR, France Telecom and Bouygues Telecom) each with its own network of GSM-type.

### STATE OF THE ART

In general, users have several telephone handsets, namely at least one fixed set (wire or cordless) to access the PSTN, and at least one mobile handset (or cellular phone or station) to access a wireless communication network. Each type of set (fixed or mobile) is associated with services, rights and a separate invoicing mode. In particular, invoicing is generally higher on the wireless communication network than on the PSTN. Users are therefore prompted to use a fixed telephone line in priority (at home or place of work etc.) to limit the use of a mobile phone solely to occasions when the user changes geographical location.

This multiplication in the number of telephone sets is a major disadvantage, and is increasingly less acceptable to users.

To overcome this major drawback, one first known solution was adopted by some users who decided to do without PSTN access. They therefore only use one telephone (namely a mobile phone) wherever they may be. The problem with this first known solution is that users are never able to benefit from some advantages (price advantages in particular) offered by the PSTN compared with the wireless communication network.

A second known solution consists of providing users with a bi-mode telephone set which is able to function either as a cordless fixed phone, when it cooperates with a base connected to the PSTN, or as a mobile phone when it does not cooperate with this base. The disadvantage of this second known solution is its complexity, high cost of the bi-mode phone set and the use of two different networks, the wireless network and the PSTN, and with no integrated services. A bi-mode set integrates both the components of a cordless fixed phone (using the DECT norm—Digital European Cordless Telecommunications) and those of a mobile phone (using the GSM norm for example).

### OBJECTIVES OF THE INVENTION

The invention sets out in particular to overcome these various disadvantages of the state of the art.

More precisely, one of the objectives of the present invention is to provide a technique making it possible for a user, at any time and wherever he/she may be, to use the same wireless phone.

A second objective of the invention is to provide said technique allowing the operator of a wireless communication network to apply different price rates, to provide different services, to grant different rights etc. according to the location from which users make a call with their wireless telephone.

A further objective of the invention is to provide said technique that is both easy to implement and low cost.

An additional objective of the invention is to provide said technique which only requires minor changes to existing equipment.

### SUMMARY OF THE ESSENTIAL CHARACTERISTICS OF THE INVENTION

These different objectives, and others which will become apparent below, are achieved according to the invention by means of a method allowing multiple use of a cellular phone, also called a station, of a type included in a wireless communication system. According to the present invention, said station may assume at least the two following functioning states, defined by at least one distinct state parameter: a so-called “mobile station” state associated with a situation of geographical mobility of said station, and a so-called “fixed station” state associated with a situation of geographical fixity of said station, inside a predetermined fixed location that is closely delimited in space. Said method comprises: at least one state switching step of said station, automatically and/or on user command, according to the geographical position of said station; at least one comparison step comparing the position of said station relative to the predetermined fixed location, so as to trigger or validate said at least one state switching step, if said station effectively moves from inside to outside said predetermined fixed location, or conversely.

The general principle of the invention therefore consists of providing (at least) two operating states—namely the “mobile station” and “fixed station” states—for one same station (or cellular phone), and a mechanism for switching between these two states. The “mobile station” state which enables roaming use of the station, corresponds to the usually permanent state of any cellular phone. The station switches from the “mobile station” state to “fixed station” state when it enters a very localised perimeter, essentially corresponding to a user's sedentary habits.

The predetermined, fixed location is advantageously a space of approximately 50 m, preferably less than 20 m. Preferably it belongs to the group comprising: precise geographic positions, private places of residence, workplaces, temporary stay locations, secondary homes, retail outlets, etc. It is evident however that other types of “sedentary” uses of the station in “fixed station” state may be considered while remaining within the scope of the invention.

Having regard to these respective quantitative and qualitative delimitations of the predetermined, fixed location, it is understood by analogy that the situation of geographic fixity of the station inside the predetermined fixed location is comparable with the situation of geographic fixity of a land telephone line (connected to the PSTN). Indeed the latter may also only be moved within a “predetermined fixed location” closely delimited in space by the length of the cable connecting the fixed phone to a telephone socket (for a fixed wire phone) or by the range between the fixed phone and the base (for a cordless fixed telephone).

It is important to note that the predetermined fixed location is not an additional geographical cell of the wireless communication network. Also, within the scope of the present invention, the station always operates, irrespective of its current state (mobile or fixed) within a system of mobile telephony (that is to say solely on a wireless communication network and never on the PSTN network). The present invention therefore does not in any way set out to provide a bi-mode mobile which operates either on a wireless communication network or on the PSTN.

The major advantage of the present invention is that each operating state may be associated with a certain number of attributes specific to it. To facilitate the use of the station in its different states, attributes common to both functioning states may be provided. A non-exhaustive list of attributes is given in the remainder of the disclosure.

For the operator, the present invention therefore offers the following advantages:

additional income associated with reduced churn and reduced cannibalisation of fixed traffic by fixed telephone operators;

maintained distinction between mobile and fixed price rates, making it possible to maintain higher rates for mobile incoming and outgoing calls;

market positioning in respect of access and associated income, to compete with traditional wire operators;

strong sales argument related to a single sales point for fixed and mobile;

low production costs as no major network impact is required.

The impact on the wireless communication network (GSM, UMTS or other) and on information systems, aside from service pricing, is practically zero. Only the subscriber identification modules need to be specifically programmed. The changes are sufficiently restricted to consider deployment on most retailed mobile stations.

For the comparison step comparing the position of the station relative to a predetermined fixed location, a presence detecting operation is performed inside the predetermined fixed location.

Under a first preferred embodiment, this presence detecting operation is made by contact/quasi-contact between said station and at least one device for detecting the presence of said station inside the said predetermined fixed location. The geographical position and extent of said predetermined fixed location are respectively defined by the geographical position of said at least one presence detection device and the range of said contact and/or quasi-contact between said at least one presence detection device and said station.

By “contact” between the station and the presence detection device is meant a physical contact, of electric, electronic, mechanical type (or a combination of several of these types). By “quasi-contact” is meant all types of proximity connections, with no physical contact.

Under a second preferred embodiment, the presence detecting operation is made by calculations based on location data derived from said wireless communication system and/or an outside locating system.

Advantageously it is possible to combine the presence detecting techniques of the above-described first and second preferred embodiments.

Advantageously (in the event that said station comprises a terminal and a subscriber identification module) in order to implement at least part of said state switching step, said terminal and/or said subscriber identification module may comprise a selection functionality to select one of said two distinct state parameters so as to define a current functioning state among said “mobile station” and “fixed station” states.

In this way, it is within the station, and preferably in the subscriber identification module, that the state switching step is performed. Evidently, however, the present invention also encompasses the case in which the state switching step is conducted (in real or delayed time) within appropriate equipment of the wireless communication network.

Advantageously, the station may comprise a forwarding function for incoming calls, consisting of forwarding to the current operating state any calls made to the station when it is in one of said operating states which is not said current operating state. With this functionality it is possible to establish a gateway, in transparent manner for callers, between the station in the “mobile station” state and the station in the “fixed station” state.

Under one advantageous embodiment of the invention, said station does not change directly from the “fixed station” state to the “mobile station” state, but passes through an intermediate state, a so-called “logic fixed station” state in which said station continues to operate until at least one predetermined event occurs, as in the said “fixed station” state, even though the conditions for switchover from “fixed station” to “mobile station” state have been verified.

Therefore, the “logic fixed station” state, which is a third operating state, is a temporary persistence of the “fixed station” state. It is of particular interest in cases when detection of the presence of the station (allowing changeover to “fixed station” state) is assured by physical contact and/or short range quasi-contact. In this case, the “logic fixed station” state allows user-friendly “cordless” use of the station when it is inside the predetermined fixed location, even though it operates with all the attributes of the ‘fixed station’ state (in particular a less costly invoicing mode for example).

Under one particular embodiment of the invention, said “mobile station” state is deactivated and replaced by a so-called “inoperative state” so that said station can assume either said “fixed station” state or said “inoperative state”.

In this case, said group of pairs of distinct state parameters may preferably also comprise the following pairs:

a mobile number and an “inoperative” state parameter

a fixed number and an “inoperative” state parameter

an IMSI and an “inoperative” state parameter.

Preferably (when said station comprises a terminal and a subscriber identification module) said contact and/or quasi-contact of said station with said presence detection device is achieved by contacting and/or quasi-contacting said subscriber identification module with said presence detection device so as to enable dialogue between said presence detection device, said subscriber identification module and said terminal.

In this manner, the terminal does not need to be modified since it is not involved in the contacting and/or quasi-contacting between the station and the presence detection device.

Advantageously, said dialogue between said terminal, said subscriber identification module and said presence detection device makes it possible to conduct said presence detecting operation of said station inside the predetermined fixed location and also at least one additional function.

It is important to note that the additional function or functions may be independent from the terminal, since the subscriber identification module may dialogue directly with the presence detection device (by contacting and/or quasi-contacting). Numerous additional functions, irrespective of their object, may be considered while remaining within the scope of the invention, such as in particular but not exclusively the functions of identification, authentication, payment, SIM card address book recharging from a PC connected to the presence detection device etc.

Under one particular embodiment, the method comprises an irreversible fixing step of said presence detection device on a non-removable building support so as to prohibit any displacement of said presence detection device.

In this way, the presence detection device is prevented from being “taken away” and moved freely with the station, with the user fraudulently maintaining a “fixed station” state. It is recalled that it is the presence detection device, through its very presence, which defines the geographical position of the predetermined fixed location. Also, it is the range of the contact and/or quasi-contact between this device and the station which defines the area size of the predetermined fixed location. Consequently, should a person with fraudulent intentions be able to freely move the presence detection device, while maintaining contact and/or quasi-contact between this device and the station, such person would also move the predetermined fixed location which is evidently unacceptable.

According to one advantageous variant, the method of the invention comprises a displacement limitation step of said presence detection device, itself comprising the following steps:

initialisation of said presence detection device,

counting the number N of displacements of said presence detection device by the user from said predetermined fixed location to another predetermined fixed location;

when said number N of displacements exceeds a maximum number Nₘₐₓ of displacements, that is predetermined or defined in adaptive manner with Nₘₐₓ≧0, triggering of a procedure prohibiting operation in said “fixed station” state and/or sending an alert to a management system and/or informing the user of said overstepping.

Here again, the objective is to prevent the presence detection device from being “taken away” and moved around freely with the station. It is to be noted that it is only when Nₘₐₓ=0 that any displacement of the presence detection device is prohibited. In other cases, that is when Nₘₐₓ≧1, the presence detection device may be moved (one or several times) from one fixed location to another. Once this or these displacements have been made, it is evident that the presence detection device must remain resident at the new location to which it has just been moved, and must not be “taken away” and moved around freely with the station.

Several variants of embodiment of this displacement limitation step of the presence detection device are described in detail in the remainder of the disclosure. Evidently several of these variants may be used cumulative fashion, so as to risk fraud risks.

Under one particular embodiment of the invention, after said contacting and/or quasi-contacting of said station with said presence detection device, said method comprises the following steps:

deactivation of at least one operating function (speaker, microphone, call reception means, . . . ) of said station, and

coupling, via said presence detection device, the use of said station with use of fixed equipment offering at least said at least one deactivated operating function,

so that in said “fixed station” state, said station may only be used with said fixed equipment.

Therefore, in the “fixed station” state, the station is deactivated at least in part to compel the use of fixed equipment. With this technique it is therefore possible to prevent the presence detection device from being “taken away” and moved around freely with the station, and therefore prevents a user from fraudulently maintaining the “fixed station” state. It can therefore be used alone or in combination with one (or more) variants of embodiment of the above-described technique (displacement limitation step of the presence detection device) having the same objective.

Should a connection to the telephone network or electricity network be used to detect displacements, advantageously a second time-delay system can be used to maintain the functioning of said presence detection device for a second predetermined length of time after it has been disconnected from an electricity network and/or telephone network, so that disconnections lasting the period of the said second time interval or less may be authorized. This would in particular give consideration to any power cuts.

Advantageously said presence detection device also acts as recharging base to recharge a battery pack included in said station, when said station is contacted and/or quasi-contacted with said presence detection device.

Under one advantageous embodiment of the invention, said at least one presence detection device may be contacted and/or quasi-contacted, optionally simultaneously, with at least two stations so as to allow detection of the presence of each of said at least two stations inside said predetermined fixed location. In this case, said predetermined fixed location is preferably made up of an area covering a few hundred meters.

This common presence detection device may for example be used by several family members in one home. Therefore, when they return home they each place their station in contact and/or quasi-contact with the same presence detection device.

A further application of the common presence detection device consists of using it as a locating beacon intended to cooperate (by quasi-contacting with a range of preferably a few hundred meters) with a plurality of stations. The fixed location is a university campus for example and the plurality of stations is held by students and professors on the campus.

Preferably, said at least one presence detection device and said station use unilateral or mutual identification and/or authentication mechanisms. This reduces the risks of fraud.

Under one particular embodiment of the invention, after contacting and/or quasi-contacting the station with the presence detection device, said method comprises a downloading step from the presence detection device to the station, in securitized manner, to download a temporary network identifier of the station and optionally at least one associated attribute, so that the station operates solely during the time of said contacting and/or quasi-contacting in said “fixed station” state with the downloaded temporary network identifier and optionally said at least one associated attribute.

Therefore the user present in a fixed location temporarily uses a downloaded network identifier allocated to the user by the occupant of this fixed location.

Under one advantageous embodiment of the invention, at the time of their contacting and/or quasi-contacting the station and presence detection device together form a relay, for at least one item of equipment provided with a telephone function and connected to said presence detection device, towards the wireless communication network to which the station is linked.

The item or items of equipment with telephone function benefiting from this relay connection towards the wireless communication network are for example telephone sets, answering machines, answerphones, PCs, etc. They are connected to the presence detection device either by cable (conventional wire technology) or by wireless communication (cordless technology using the DECT norm for example). One same presence detection device may be provided with several types of interfaces enabling its connection to different types of equipment using different types of connections.

The invention also concerns a system allowing multiple use of a cellular phone, and several parts taken separately (a cellular phone, a subscriber identification module and a presence detection device) in that they comprise specific means enabling the application of the above-mentioned method.

### LIST OF FIGURES

Other characteristics and advantages of the invention will become apparent on reading the following description of several preferred embodiments of the invention, given by way of illustration and non-restrictive, and appended drawings in which:

FIG. 1 shows a simplified partial schematic of a wireless communication system within which the method of the present invention can be applied;

FIG. 2 illustrates a particular embodiment of the operation detecting the presence of a station inside a predetermined fixed location, based on the use of a presence detection device;

FIGS. 3 and 4 each show a diagram of station operating states under a first and second embodiment of the invention respectively;

FIGS. 5, 6 and 7 illustrate three variants of the presence detection device in FIG. 2.

FIGS. 8 and 9 each illustrate a particular embodiment of the quasi-contacting of a presence detection device with a subscriber identification module;

FIG. 10 illustrates the implementation of an additional function via a dialogue between the subscriber identification module and the presence detection device;

FIG. 11 shows a simplified flowchart of one particular embodiment of a displacement limitation step for the presence detection device;

FIG. 12 illustrates a particular embodiment of deactivation of the functionality(ies) of a station, to compel the use of fixed equipment connected to the presence detection device;

FIG. 13 illustrates a variant embodiment of the invention, in which several stations may be simultaneously contacted and/or quasi-contacted with one same presence detection device;

FIGS. 14 and 15 each illustrate a variant embodiment of the immobilisation of the presence detection device;

FIG. 16 shows a diagram of the state of the presence detection device in cases when the variant embodiment illustrated in FIG. 15 is implemented with a removable battery.

### DESCRIPTION OF PARTICULAR EMBODIMENTS OF THE INVENTION

Summary of Background

The invention therefore concerns a method and a system enabling multiple use of a cellular phone within a wireless communication network. Below, the cellular phone is also called a “station” (not to be confused with a “base station” [BTS] such as described below).

In the remainder of the description, it is assumed that the station comprises a terminal cooperating with a subscriber identification module. In the remainder of the description the subscriber identification module is called a SIM card (GSM terminology) without this meaning however that the invention is limited to this particular type of subscriber identification module.

Also, the invention also evidently applies to a station which does not comprise a subscriber identification module. In this case, the terminal assures the operating functions which, in the remainder of the description, are described as being assured by the subscriber identification module.

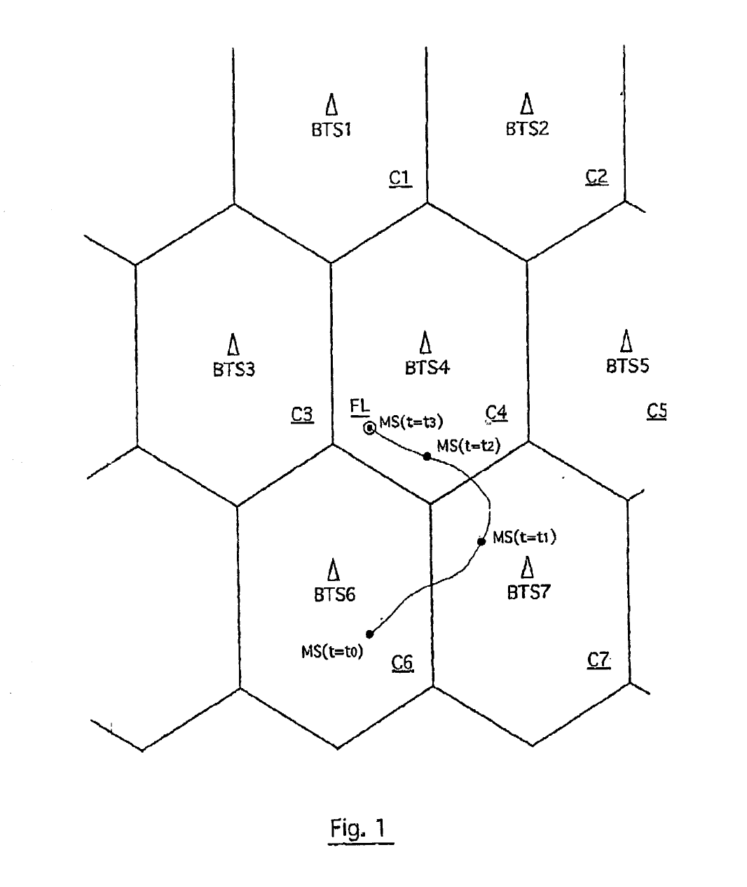

Conventionally, in a wireless communication system (according to the GSM standard for example), each subscriber is provided with a station, a so-called mobile station, with which to emit or receive calls while moving within a predetermined geographical area. As illustrated in the simplified schematic in FIG. 1, this roaming space for mobile stations is broken down into a network of adjacent geographical cells C1, C2, C3, etc. Each cell is associated with a separate emitting/receiving base station (or BTS according to the GSM standard) BTS1, BTS2, BTS3, etc.

It is to be noted that diagram 1 is simplified as in fact the geographical cells overlap. One location is therefore covered by several cells (typically 6 to 8 in Paris) and one among them, the so-called main cell, processes most of the calls. If this main cell is saturated, the mobile station “catches” an adjacent cell. Therefore, in the example illustrated in FIG. 1, the mobile station MS catches cell C6 at time to, and then successively catches cells C7 (at time t₁) and C4 (at time t₂).

The base stations are linked to base station controllers (or BSC in the GSM standard) themselves linked to mobile switching centres (MSC in the GSM standard) allowing interconnection of the wireless communication system with the public switched telephone network (PSTN). The wireless communication system is also sometimes called the wireless communication network through misuse of language.

Conventionally, a station (or cellular phone) therefore always operates in the same state which can be qualified as a “mobile station” state, since it is associated with a situation of station geographical mobility within the network of geographical cells.

General Concept of the Invention: Dual “Fixed Station” and “Mobile Station” State.

Under a first embodiment of the present invention, the station may also assume another state, namely a “fixed station” state. Each state, “mobile station” or “fixed station”, is defined by one (or more) distinct state parameter(s).

The “fixed station” state which does not exist in current wireless communication systems, is associated with a situation of geographical fixity of the station inside a predetermined fixed location.

To manage the operating state of the station, the method of the invention comprises:

at least one station state switching step, either automatic and/or on user command, in relation to the geographical position of said station;

at least one station position comparison step relative to a predetermined fixed location, so as to trigger or validate the state switching step, in real or delayed time, if the station is effectively moved from inside to outside said predetermined fixed location, or conversely.

A diagram of station states, corresponding to this first embodiment of the invention, is given in FIG. 3. The MS station changes over from the “mobile station” state to “fixed station” state if it enters (or returns) inside the fixed location FL. Conversely, it changes over from the “fixed station” state to “mobile station” state when it leaves the fixed location.

State Attributes

Each operating state is associated with a certain number of attributes specific to it. Optionally, common attributes may be provided for both operating states. In general, all possible combinations of own specific and common attributes may be considered, in particular on the basis of the following attributes (non-exhaustive list):

invoicing modes for incoming calls;

invoicing modes for outgoing calls;

telephone numbers;

roaming rights;

rights to international calls;

added value functionalities and/or services (directory, WAP content services, etc);

Internet access functionalities and/or services via the wireless communication network to which the station is linked;

Access functionalities and/or services to data and/or fax services;

Voice mail functionalities and/or services;

Call forwarding functionalities and/or services;

Address book functionalities and/or services;

Directory functionalities and/or services;

etc.

It is possible for example for the marketing department of an operator's wireless communication network to decide which attributes are specific to each state and which are to be common to both states. This choice may for example consist of allocating to the “fixed station” state the same attributes as those traditionally allocated by the PSTN operator to a fixed telephone set (wire or cordless) connected to the PSTN. Therefore, in this particular case when users use the station in “fixed station” state, they benefit from all the advantages (prices rates in particular) that are usually offered by the PSTN compared with the wireless communication network. With the invention, users therefore have no reason to accumulate a fixed telephone set and a mobile telephone set (cellular phone) and may simply have only the cellular phone. In other words, the invention brings continuity of use of the station within the predetermined fixed location (the home for example) as with mobile use. More generally, the operator of the wireless communication network may choose the attributes specific to each state in numerous ways, optionally as per user requested needs.

Example of Invoicing Policy in Relation to Operating States

The table below gives an example of invoicing policy in relation to operating states and to types of calls (incoming or outgoing):

| | | | | |
|---|---|---|---|---|
| | incoming | incoming | outgoing | outgoing |
| | call to | call to | call from | call from |
| | mobile | fixed | mobile | fixed |
| | number | number | number | number |
| “fixed | free | fixed rate | not | fixed rate |
| station” | forwarding | paid by | applicable | paid by |
| state | to fixed | caller | (call | caller |
| | number | | stopped by | |
| | | | station) | |
| “mobile | mobile | optional | mobile | not |
| station” | price rate | forwarding | price rate | applicable |
| state | | paid by | | (call |
| | | person | | stopped by |
| | | called | | station). |

State switching step

The state switching step is based on a change in parameters within the SIM card and/or the terminal through a selection functionality used by the card or terminal to select one of the two distinct state parameters. The selected state parameter (“mobile station” state or “fixed station” state) forms the current operating parameter.

Predetermined Fixed Location

The predetermined fixed location is closely delimited in space. It is for example an area of approximately 50 m, preferably less than 20 m (even a few centimeters). It may for example be a precise geographical position, a private home, a workplace, a temporary place of residence, a secondary home, a retail outlet, etc. In the example illustrated in FIG. 1, it is assumed that at time t₃, the station moves inside the predetermined fixed location FL and switches over from the “mobile station” state to “fixed station” state while continuing to be linked to the cell denoted C4 via the base station denoted BTS4.

Position Comparison and State Switching Steps

In general, the triggering of the switching step may be automatic (through appropriate triggering means included in the station or in an item of equipment of the wireless communication network) and/or on user command (by means of appropriate command means contained in the station).

The comparison step(s) may be made before or after the switching step(s).

Embodiment n°1: Use of a Presence Detection Device

Two principle modes of embodiment of the position comparison step will now be described, and more precisely a presence detecting operation to detect the presence of station MS within the fixed location FL.

Under the first embodiment of the position comparison step illustrated in FIG. 2, (at least) one presence detecting device PDD is used and it is considered that the station is present inside the fixed location if contacting and/or quasi-contacting of the station is detected with the presence detection device. Station operation in “fixed station” state may therefore be subject either to its contacting with the presence detection device or its quasi-contacting with this device, or its simultaneous contacting and quasi-contacting with this device. The geographical position C and extent E of the predetermined fixed location are respectively defined by the geographical position of the presence detection device and the range of contact and/or quasi-contact between the presence detection device and the station. In particular, the fixed location is limited to a point (or precise geographical position) for cases when the range of contact is zero by definition. It is therefore solely in the event of quasi-contacting with a range greater than zero by definition that the fixed location has a non-zero extent E.

By “contact” between the station and the presence detection device is meant a physical contact, of electric, electronic, mechanical type for example. (or a combination of several of these types).

The notion of “quasi-contact” between the station and the presence detection device covers all types of proximity connection with no physical contact. It is preferably a short range quasi-contact(approximately 0.1 cm to 2 m) and/or medium range (approximately 0.1 cm to 50 m) by electromagnetic waves of any kind (including optic) or a short range (0.5 cm to 2 m) and/or medium range (approximately 0.1 cm to 50 m) quasi-contact by sound or ultrasound waves. Several preferred implementation techniques of this quasi-contact are described in detail in the remainder of the description (“Contactless”, “tags”, infrared”, “Bluetooth”, wireless local networks”).

In general, the presence detection device may be placed in contact and/or quasi-contact with any part of the station, that is to say in particular either solely the SIM card or solely the terminal or both (SIM card and terminal).

Through this contacting and/or quasi-contacting, the presence detection device and the station use unilateral or mutual identification and/or authentication mechanisms to avoid fraud.

In the example illustrated in FIG. 2, the station is contacted and/or quasi-contacted with a single presence detection device. The invention evidently also concerns cases when detection of the presence of the station in a predetermined fixed location is subject to contacting and/or quasi-contacting of the station with several presence detection devices simultaneously. For example, it may be required, whether simultaneously or not, to contact a first presence detection device and to quasi-contact a second presence detection device.

Embodiment n°2: Calculations Based on Locating Data

Under the second embodiment of the position comparison step, the presence of the station is detected inside the fixed location by calculations based on:

locating data derived from the wireless communication system, such as cell information for example, optionally weighted with at least one technical parameter (such as the intensity of the signal received from each cell and/or Timing Advance information; and/or

locating data derived from an external locating system such as GPS data for example.

These calculations may be of absolute or differential type (as regards the position of the predetermined fixed location as defined during an initialisation phase). They are made by the terminal and/or SIM card and/or a server (or other equipment) in the wireless communication network.

Combination of Embodiments n°1 and 2

It is advantageously possible to combine the first and second embodiments described above. This combination consists for example of conducting presence detection according to the two above-described techniques, then only selecting the result whose error likelihood is judged to be the lowest. It may also be chosen to take a decision taking into account the, optionally weighted, results of the two above-described techniques. For example, the station is detected in absolute manner by the presence detection device and in approximate manner by the locating system (wireless communication system and/or GPS or other) and the changeover is related to positive locating (that is to say inside the fixed location) of both manners. A further alternative is to take a real-time decision based on the result of one of the techniques, then to validate this decision, in delayed time on the basis of the result of the other technique. Numerous other combinations can evidently be considered while remaining within the scope of the present invention.

State Parameters

A detailed description follows of the state parameters defining the “mobile station” and “fixed station” states. A distinction is made below between two cases according to whether the state parameters are or are not network identifiers of the station.

Case n° 1: the State Parameters are Network Identifiers

In the first case, the two distinct state parameters, each defining one of the operating states, are network identifiers of the station. They therefore implicitly form state transmission parameters towards the wireless communication network. In other words, each of the operating states is defined in the station by a special network identifier. During exchanges between the station and the wireless communication network, the network identifier defining the current state is used (this is the primary function of this type of network identifier) which enables the wireless communication network to know (in real or delayed time) the current operating state of the station.

In particular, the following network identifiers may be used: IMSI, mobile numbers (MSISDN), fixed numbers, “inoperative” state parameters. It is recalled that IMSI and MSISDN are the two fundamental network identifiers of any mobile subscriber. IMSI stands for International Mobile Station Identity and is the mobile subscriber's international identity. MSISDN stands for Mobile Station Integrated Service Data Network and is also called the mobile number (in French RNIS: Réseau Numérique à Intégration de Service). By fixed number is meant a telephone number generally allocated by an operator to a non-mobile station. Fixed numbers are of two types: geographical telephone numbers associated with a given location (standard numbers allocated by operators to private persons or businesses, for example 01 71 xx xx xx) and non-geographical telephone numbers (numbers allocated by traditional operators to businesses and at times to private individuals as toll-free or other special numbers, for example 0824 xx xx xx). The notion of the “inoperative” state parameter is discussed in detail further on. It applies in particular to the case when the “mobile station” state is replaced by an “inoperative station” state.

Case n°2: the State Parameters are not Network Identifiers

In the second case, the two distinct state parameters each one defining one of the operating states, are state parameters that are internal to the station. They are therefore not network identifiers of the station. Yet it is essential for the wireless communication network to know the operating state of the station, in real or delayed time. To meet this necessity, the station transmits state transmission parameters towards the wireless communication network. In other words, in this second case, the state parameter used in the station to define the current operating state is internal to the station. It is not the same as the state transmission parameter used to inform the wireless communication network of this current operating state. State transmission parameters are transmitted for example by modifying the number called, for example by adding a specific predetermined prefix. It is also possible to use a sub-address of the caller number, or an unused field of the communication and/or signalling protocol between the station and the wireless communication network.

Examples of State Parameter Pairs

In the first as in the second case, at the time of an outgoing call, the network transmits the new state of the station in transparent manner within the signalling. No real time or centralised system for location management is required.

To summarise, the following pairs of state parameters may be given particular consideration:

two IMSIs;

two MSISDNs;

two fixed numbers;

one MSISDN and one fixed number;

one MSISDN and one “inoperative’ state parameter

one fixed number and one “inoperative” state parameter

one IMSI and one “inoperative” state parameter

two state parameters internal to the station.

This list is in no way exhaustive and other pairs of state parameters may be contemplated while remaining within the scope of the present invention.

Forwarding Functionality for Incoming Calls

Optionally, the station comprises a forwarding functionality for incoming calls, consisting of forwarding to the station in its current operating state (“mobile station” state for example) any incoming calls that are intended for the station when it is in an operating state (“fixed station” state in the cited example) which is not its current operating state. This call forwarding function is therefore applied when the request for establishing an incoming call explicitly refers to one of the operating states of the station. This is the case for example if each state has its own telephone number and if the request for establishing an incoming call specifies one of these telephone numbers. The user may be offered the choice of activating this call forwarding function or not, or of implementing this choice in permanent manner. It is also possible to provide for selective activation of this functionality, for example only for certain incoming calls.

Replacing “Mobile Station” State by an “Inoperative Station” State

In one variant of the first embodiment described above, the “mobile station” state is deactivated and replaced by an “inoperative station” state. The two states which the station can assume are therefore the following: “fixed station” state and “inoperative station” state. Consequently, the station can only emit or receive calls (or communications) if it is in “fixed station” state (or “logic fixed station” state if the station is able to assume this third state; see discussion below). This amounts to providing the user with a station intended solely for sedentary use (defined by the set of attributes associated with the “fixed station” state), even though it operates on a wireless communication network (and never on the PSTN network).

Third State: “Logic Fixed Station”

Under a second embodiment of the present invention, the station may, in addition to the “mobile station” and “fixed station” states described above assume another state, namely a “logic fixed station” state. This allows “cordless” use of the station in the “logic fixed station” state.

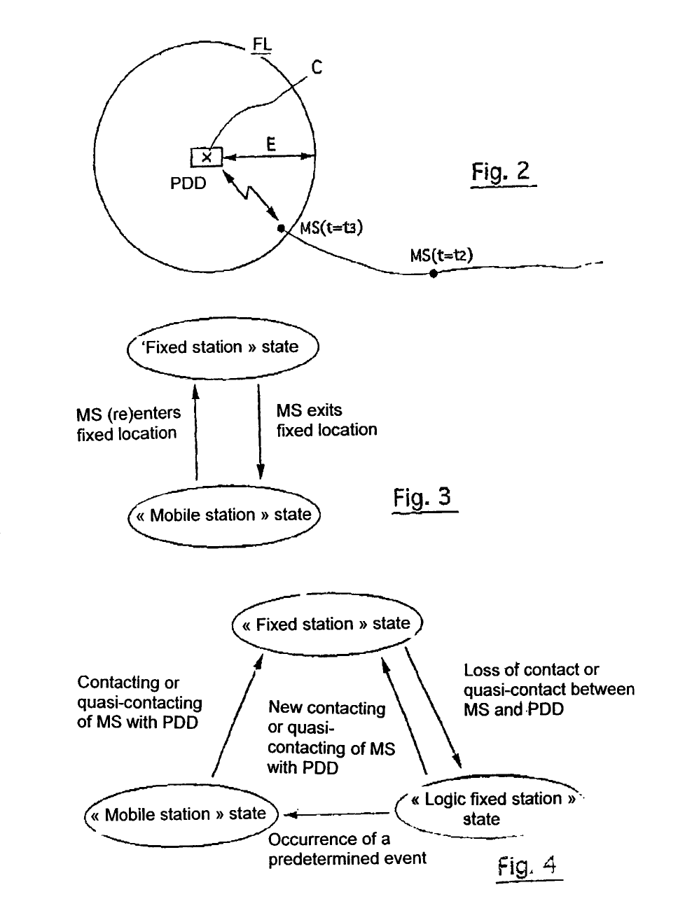

A diagram of station states describing this second embodiment of the invention is given in FIG. 4. Without being restrictive, the case illustrated corresponds to the use of a presence detection device to detect the presence of the station inside the fixed location.

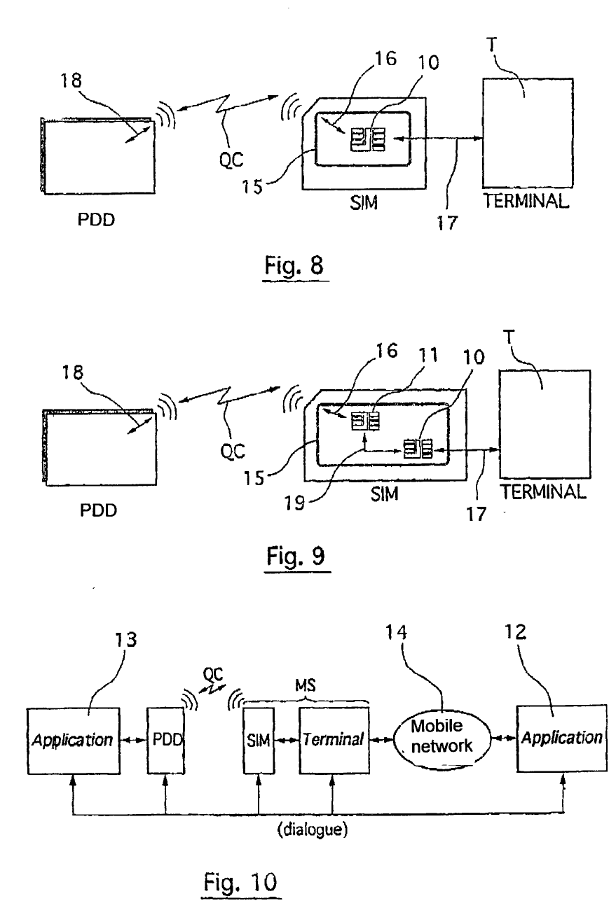

The MS station switches from the “mobile station” state to “fixed station” state if it is placed in contact or quasi-contact with the presence detection device (entry into the fixed location FL). On the other hand, contrary to the first embodiment (cf. FIG. 8) it does not switch directly from the “fixed station” to “mobile station” state when it loses contact or quasi-contact with the presence detection device (leaves the fixed location). Instead it switches to a “logic fixed station” state which is temporary persistence of the “fixed station” state (in the sense that the station continues to operate as a “fixed station” even though the conditions for switching from “fixed station” to “mobile station” have been verified). It is only when a predetermined event occurs that the station switches from “logic fixed station” to “mobile station”. In addition, if the station is replaced in contact or quasi-contact with the presence detection device (re-entry into the fixed location) while it is in “logic fixed station” state, it switches over to “fixed station” state.

Several variants of the predetermined event are described below which terminate the “logic fixed station” state and prompt switching over to “mobile station” state.

First Variant of the Event Terminating “Logic Fixed Station” State

In a first variant, the predetermined event is the completion of a time delay. For the first embodiment of the position comparison step described above (use of a presence detection device) this time delay is armed when contact and/or quasi-contact ceases between the station and presence detection device. For the second above-described embodiment of the position comparison step (calculations based on locating data derived from the wireless communication system and/or external locating system), this time delay is armed if this locating data changes or is lost. Optionally, if communications are established or received after arming of the time delay, the initial length of the time delay may be extended by the length of the communication time. In this manner, a communication in progress, established with the station in “fixed station” state is authorized to reach completion before switching over to “mobile station” state.

Second Variant of the Event Terminating the “Logic Fixed Station” State

In a second variant, the predetermined event is the occurrence of a network event within the wireless communication network. Different network events may be considered for setting this functionality in operation. It may in particular be a periodic location update, a handover, a change in attachment cell, a change in relative position, loss of contact with one or more adjacent cells, etc.

Third Variant of the Event Terminating the “Logic Fixed Station” State

In a third variant, the predetermined event is voluntary action by the user of the station

Fourth Variant of the Event Terminating “Logic Fixed Station” Status

In a fourth variant, the predetermined event is a change in relative position of the station, estimated in differential manner by comparison between the current position of the station and its last position(s) in contact and/or quasi-contact with the presence detection device.

Position comparison may be made in particular by calculating the current position of the station within the space of geographical cells C1, C2, . . . perceived by the station, then comparing with the last position(s) perceived by the station when it was in contact and/or quasi-contact with the presence detection device. The calculation of each position P (“current” or “last”) is expressed in the form: P=λC1+μC2+ . . . +νCN where λ, μ . . . , ν are weighting coefficients representing either the intensity of a signal received by the station, or a function of this intensity, or a time shift in signal propagation to the station, or a time shift function, or a combination function of at least two of these representation methods.

Alternately, position comparison may be made by determining the displacement of the station using a device integrated within the station. This integrated device is preferably in the SIM card and comprises:

a position and/or displacement and/or speed and/or acceleration sensor and/or at least one inclinometer,

a chip (or “calculation and memory unit”) which may or may not be separate from the standard chip of the SIM card, and

if there are two separate chips, a communication channel between them.

With reference to FIGS. 4 to 16 various characteristics will now be described connected with the first above-mentioned embodiment of the position comparison step, based on the use of a presence detection device.

Presence Detection Device and Optional Associated Telephone Sets

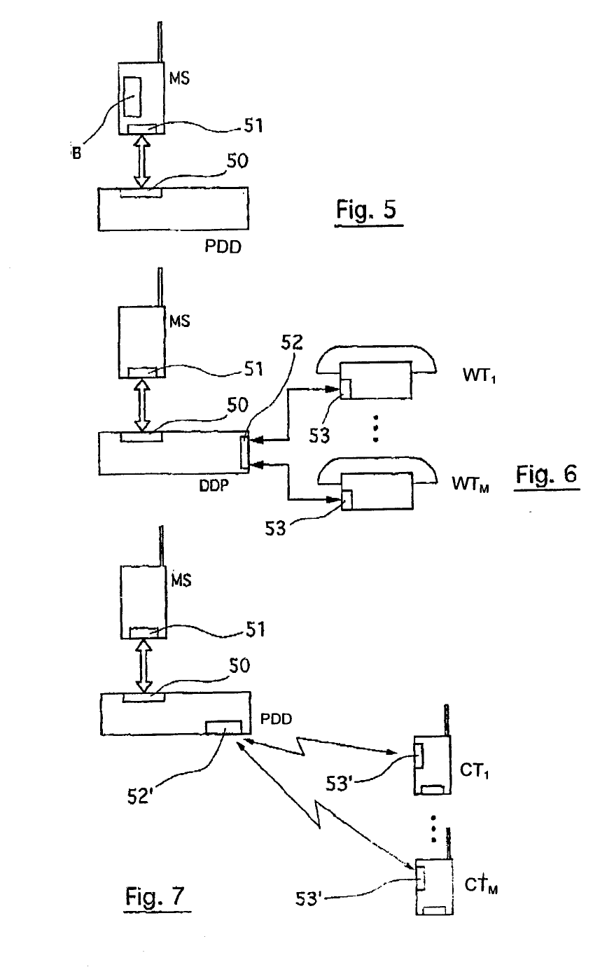

FIGS. 5, 6 and 7 illustrate three variants of the presence detection device PDD shown in FIG. 2.

In the first variant, the presence detection device PDD comprises a single type of interface means 50, intended to cooperate with interface means 51 contained in the station MS at the time of contacting and/or quasi-contacting of the MS station with the presence detection device PDD. In other words, in “fixed station” state or “logic fixed station” state only the station may be used to communicate via the wireless communication network.

In the second variant, the presence detection device PDD also comprises a second type of interface means 52, cooperating with wireline interface means 53 included in one or more wired telephone sets WT₁ to WT_{M}. Therefore at the time of station contacting and/or quasi-contacting with the presence detection device, it is possible to use this (these) wire phones in addition to the station.

The third variant differs from the second solely in that the second type of interface means 52′ included in the presence detection device PDD are of cordless type (for example of DECT standard type) instead of wireline type. They therefore cooperate with the cordless interface means 53′ included in one or more cordless telephones CT₁ to CT_{N}.

In other words, in the second and third variants, the MS station and the presence detection device, during their contacting and quasi-contacting, together form a relay towards the wireless communication network for at least one telephone set (wire or cordless) connected to the presence detection device. Evidently, one of the wire or cordless telephones may be replaced by an answering machine (or any other equipment whose connection to the wireless communication network is of interest). It is also evident that one same presence detection device may be connected firstly to at least one wire telephone and to at least one cordless telephone (combination of the second and third variants).

Charger Base Function of the Presence Detection Device

Optionally, the presence detection device PDD also has the function of a recharging base with which to recharge battery B included in the station (as shown in FIG. 5 for example), when the station is contacted and/or quasi-contacted with the presence detection device.

Quasi-Contact Between SIM Card and Presence Detection Device

With reference to FIGS. 8 and 9 a description is given below of two variants of the configuration according to which the SIM card is placed in quasi-contact QC with the presence detection device PDD.

Usually, the SIM card comprises a (first) chip 10. By chip is meant a calculation and/or memorizing unit, analog or digital, integrated in or joined to the SIM card.

In the first variant (cf. FIG. 10) this (first) chip 10 includes means for implementing quasi-contact QC, forming an emitting/receiving interface 16 of the SIM card to/from the presence detection device PDD. Usually the SIM card also comprises a dialogue interface 17 with terminal T. The presence detection device also comprises means for implementing quasi-contact QC, forming an emitting/receiving interface 18 of the presence detection device PDD to/from the SIM card. For example, frequencies of 13.56 MHz or 433 MHz (or other) are used on the emitting/receiving interfaces denoted 16 and 18.

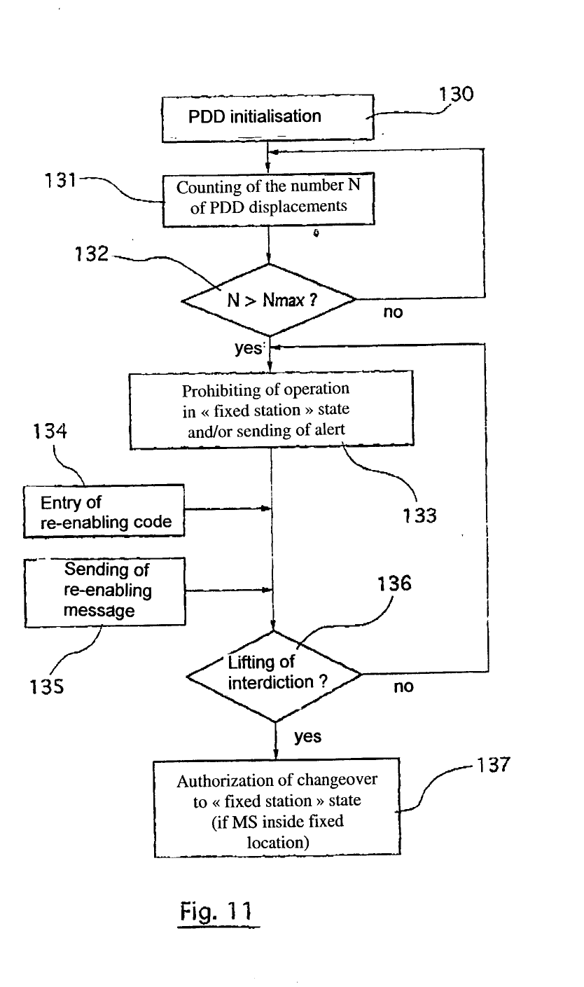

In the second variant (cf. FIG. 11), the SIM card also comprises a second chip 11, and it is in this chip that the quasi-contacting implementation means are contained. The first and second chips 10, 11 may be simultaneously and/or alternately active and dialogue together. They are included either on one same substrate or on different substrates. At all events they are connected by a communication channel (cable, ribbon) forming a dialogue interface 19 between chips 10, 11. Two types of supply to the second chip 11 may be considered. Either it is supplied by the terminal (as is usual for the first chip 10) and forms an active tag. Or it draws its energy from a signal derived from the presence detection device, and more precisely from a signal emitted by a fixed contactless coupler positioned inside the presence detection device. The range of quasi-contact is greater if energy is supplied by the terminal.

Regardless of the chip in which the means for implementing quasi-contact QC are contained, the latter comprise an aerial coil 15 and operate for example according to either one of the “Contactless” or “Tag” technologies described below.

Additional Function via a Dialogue Between SIM Card and Presence Detection Device

Their contacting and/or quasi-contacting enables the SIM card and the presence detection device to dialogue together in uni or bi-directional manner. This direct dialogue enables them to conduct the station presence detecting operation inside the predetermined fixed location. By extension, it can be considered that it is also a dialogue between the terminal and the presence detection device since, in conventional manner, the SIM card is able to dialogue with the terminal.

Optionally, this dialogue between the presence detection device, the SIM card and the terminal may also carry out one or more additional functions. These are for example SIM card identification functions by the presence detection device, or vice-versa, or authentication functions of the subscriber identification module by the presence detection device, or vice-versa. In addition, the dialogue may be encrypted. More generally, as illustrated in FIG. 10, any type of data exchange may be considered, irrespective of subject (identification, authentication, payment, address book loading, . . . ) between:

firstly the terminal and/or SIM card and/or at least one item of equipment or at least one computer application 12 located on and/or upstream from the wireless communication network 14 to which the MS station has access,

secondly, the presence detection device PDD and/or at least one item of equipment or at least one computer application 13 located downstream from the presence detection device.

Technological Options for Producing Quasi-Contact Between Station and Presence Detection Device

Different technological options are described below for producing quasi-contact between the station and the presence detection device. These technological options preferably, but not exclusively, apply to the particular case when it is the SIM card which is placed in quasi-contact QC with the presence detection device (see in particular the two variants described above with reference to FIGS. 8 and 10).

First Technological Option for Producing Quasi-Contact

According to a first technological option, quasi-contacting is achieved using the “Contactless” technique whose methods are based on adaptation (in particular to the format and constraints of micro SIM cards for example) of ISO 14443 and 15693 norms. This produces short range quasi-contact (approximately 0.1 cm to 2 m) by electromagnetic waves.

Second Technological Option for Producing Quasi-Contact

According to a second technological option, quasi-contacting is produced by means a technique which uses active and/or passive “Tags”. With this option, short range quasi-contacting is achieved (approximately 0.1 cm to 2 m) and medium range (approximately 0.1 cm to 50 m) by electromagnetic waves.

Third Technological Option for Producing Quasi-Contact

According to a third technological option, quasi-contacting is achieved using infrared communication techniques (IrDa). Medium range quasi-contact is produced (approximately 0.1 cm to 50 m) by electromagnetic waves.

Fourth Technological Option for Producing Quasi-Contact

A fourth technological option for achieving quasi-contact uses a “Bluetooth” type communication technique (in particular as per specification 1.0B “Core and profile” of Dec. 1^{st} 1999). This achieves medium range quasi-contact (approximately 0.1 cm to 50 m) using electromagnetic waves.

It is recalled that the “Bluetooth” technique is intended for all types of private radio exchanges by means of data exchange between two chips contained in two items of equipment called “Bluetooth equipment”. Each of these two chips is able to emit and receive data by ultrahigh frequency radio wave over a radius of 10 meters or more.

It is proposed to enrich the Bluetooth norm and profiles, undergoing further development, with a mechanism enabling two processes (or applications), one on the SIM card and the other on the presence detection device (the latter forms “Bluetooth equipment” in the above-cited meaning), to exchange asynchronous messages, that is to say triggered on the initiative of either one of the two processes. In other words, “Bluetooth” type communications enabling the above-mentioned quasi-contact are implemented by the exchange of asynchronous messages between the two above-mentioned processes.

The process performed by the SIM card is for example based on the two following asynchronous data messages, send and receive respectively, towards the presence detection device (this device is called “Bluetooth” in message names):

SIM_send_to_Bluetooth (@address of Bluetooth application,@data);

SIM_receive_from_Bluetooth (@address of Bluetooth application, @data).

The process performed by the presence detection device is based for example on the two asynchronous data messages, send and receive respectively, towards the subscriber identification module:

Bluetooth_send_to_SIM (address of SIM application, @data);

Bluetooth_receive_from_SIM (@address of SIM application, @data).

It is to be noted that this mechanism of exchange of asynchronous messages may be extended to any type of interface between the SIM card and local equipment, via terminal serial interfaces (ports AT)

Current GSM standards do not allow exchange between two asynchronous processes, one operating on the SIM and the other operating on equipment (TE for “Terminal Equipment’ in GSM terminology) connected to the serial port of the mobile. As above, new messages SIM_send_to_AT, SIM_receive_from_AT, AT_send_to_SIM, AT-received_from_SIM linking the “SIM toolkit” interface between the SIM and the mobile terminal with the AT serial interface between the terminal and external equipment (TE) would make it possible to achieve this objective.

Fifth Technological Option for Producing Quasi-Contact

According to a fifth technological option, quasi-contacting is achieved using the communications technique via local wireless networks (conforming in particular to specifications ETSI 300 328 and 300 826). Medium range quasi-contact is achieved (approximately 0.1 cm to 50 m) by electromagnetic waves.

Sixth Technological Option for Producing Quasi-Contact

According to a sixth technological option, quasi-contacting is achieved using the communications technique via electromagnetic links within the 400 MHz or 900 MHz band. Medium range quasi-contact is achieved by electromagnetic waves.

Seventh Technological Option for Producing Quasi-Contact

A seventh technological option, the presence detection device, has a simplified base station simulating function, and is associated with a geographical pseudo-cell having an identifier. Quasi-contacting is achieved when the SIM card (or more generally the station) recognizes the identifier of the geographical pseudo-cell. This recognition is based for example on standard mechanisms of the SIM ToolKit application. Also, the identifier of the geographical pseudo-cell may be emitted in encrypted form by the pseudo base station emulated by the presence detection device.

Prohibited Displacement of the Presence Detection Device

In order to prohibit any displacement of the presence detection device, this device may be fixed in irreversible manner onto a fixed, non-removable building support. This building support may be a wall in the entrance hall of the user's home, if the predetermined fixed location is the place of residence of this user.

Limited Displacements of the Presence Detection Device

According to one alternative, only a maximum number Nₘₐₓ of displacements of the presence detection device are authorized from one fixed location to another.

FIG. 11 shows a simplified flowchart of a particular embodiment of said limited displacement of the presence detection device.

The steps involved are the following:

initialisation 130 of the presence detection device PDD;

counting 131 the number N of displacements of the presence detection device from one predetermined fixed location to another;

comparing 132 the number N of displacements with a maximum number of displacements Nₘₐₓ;

if N>Nₘₐₓ, triggering of 133 procedure prohibiting operation in “fixed station” state and/or sending an alert to a management system and/or informing the user of overstepping;

otherwise (N≦Nₘₐₓ) and return to counting step 131.

In general, the maximum number Nₘₐₓ is predetermined or defined adaptive fashion. It is equal to zero or over. When it is zero, this amounts to prohibiting any displacement of the presence detection device from one fixed location to another without however (contrary to the preceding embodiment) fixing it in irreversible manner on a non-removable building support.

It is to be noted that limited displacements (“micro-displacements”) are authorized provided they do not amount to a displacement from one fixed location to another. By limited displacements is meant for example displacements within a closely delimited place (flat, house, . . . ). The limit between “displacement from one fixed location to another” and “limited displacement” may be defined using several criteria such as for example a threshold representing a determined maximum distance (see detailed examples below).

Initialisation step 130 is conducted periodically, and/or on receipt of a message (for example a short SMS message) from the wireless communication network and/or according to a predetermined initialisation strategy, and/or after each (re)connection of the presence detection device to the electricity network and/or to the switched telephone network, etc.

Procedure 133 prohibiting functioning in “fixed station” state consists for example of blocking the presence detection device or the station. This blocking may be achieved by example by software deactivation of a chip contained in the presence detection device or accessorily in the SIM card, subsequent to a change in status of this chip or of a permanent memory to which this chip is connected (see appendix).

Alternately, procedure 133 prohibiting functioning in “fixed station” state may also consist of applying a first time delay preventing changeover of the station to “fixed station” state during a first predetermined length of time after detected overstepping of the number N of displacements which becomes greater than the maximum number of displacements Nₘₐₓ.

This first time delay is for example implemented in the presence detection device. This amounts to blocking the presence detection device for the duration of the first time delay. In this way, station operation in the “fixed station” state is prevented but not in “mobile station” state.

The length of the first time delay is for example 24 hours. Numerous other time values may evidently be considered while remaining within the scope of the invention. This first time delay may in particular be infinite (in this case blocking is definitive).

In addition, the length of the first time delay may be dynamically adaptable. It may for example be increased (for example by 24 hours) after each displacement of the presence detection device, so as to limit any fraud in particular.

Optionally, as illustrated in FIG. 11, lifting 137 of prohibited functioning in “fixed station” state may be authorized. This lifting of the interdiction may for example be subject (136) to entry 134 by the user of a re-enabling code into the station and/or presence detection device. This re-enabling code may vary with each re-enabling and conform either to a predefined algorithm, or to a predefined list of re-enabling code values. The algorithm and/or list are different for each presence detection device. Lifting of the interdiction may also be subject (136) to the sending 135, by the wireless communication network, of a message (for example a short SMS message) towards the station and/or presence detection device via the station. Other operations for lifting this interdiction may evidently be considered while remaining within the scope of the present invention.

First Variant of the Counting Step to Count the Number of Displacements of the Presence Detection Device

According to a first variant, counting step 131 to count the number N of displacements, after initial connection and associated initialisation, consists of counting the number of reconnections of the presence detection device to an electricity network and/or a telephone network (the PSTN network for example). In other words, it is considered that each reconnection is an indication of a displacement of the presence detection device.

It will be noted that taking Nₘₐₓ to be equivalent to zero, amounts to controlling the permanence of the initial connection of the presence detection device to the electricity network and/or telephone network.

In this case, the first above-mentioned time delay is triggered whenever the presence detection device is connected or reconnected to the electricity network and/or telephone network. This avoids the presence detection device from being disconnected and reconnected too frequently. In the remainder of the description, the interaction of this first time delay with a second time delay is discussed, authorizing short connection interruptions.

Second Variant of the Counting Step to Count the Displacements of the Presence Detection Device

According to a second variant, step 131 to count the number N of displacements consists of counting the number of times when a distance covered by the presence detection device, after a given initialisation, exceeds a maximum distance.

In this case, the presence detection device is provided with means to estimate the distance covered and particularly includes for example:

at least one displacement and/or speed and/or acceleration sensor and/or at least one inclinometer, with which to generate elementary events;

calculation means (a chip for example) to calculate an estimated distance, using a function (e.g. a sum or integration) of these elementary events.

Whenever the value of this elementary event function exceeds a determined threshold, the number of times the maximum distance is exceeded is incremented by one unit (and hence the number N of displacements of the presence detection device).

The determined threshold represents the above-mentioned maximum distance. It is adjusted so that it allows limited displacements within the fixed location, for example inside a flat. It may also be downloaded into the presence detection device by the sending of a message (SMS for example) from the wireless communication network transiting via the station.

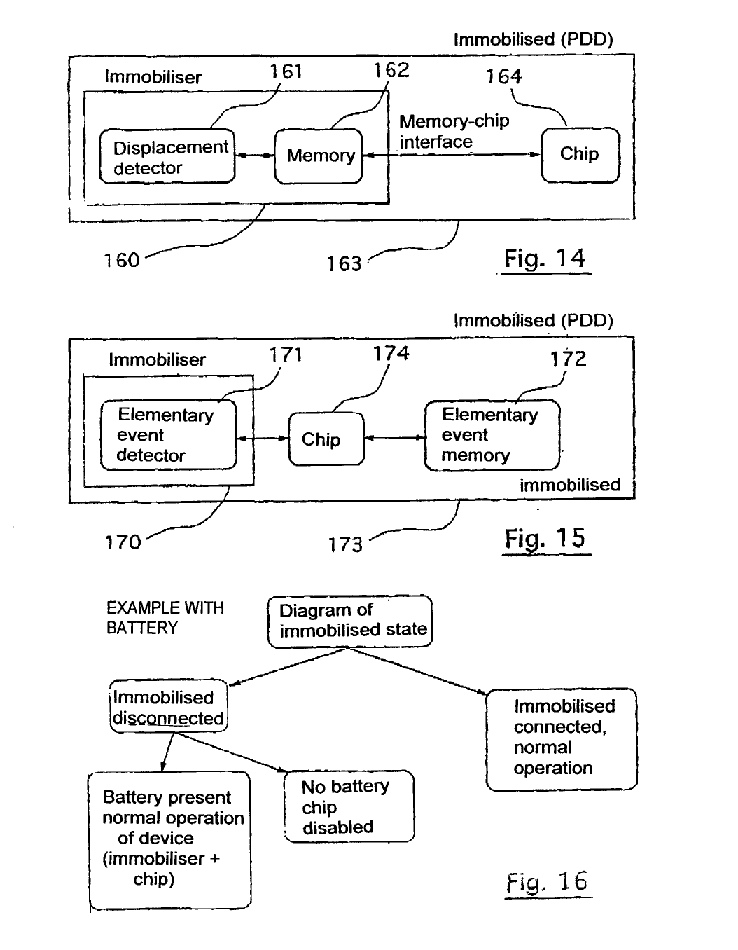

A detailed description is given in the appendix with reference to FIGS. 14 to 16 of two examples of embodiment of this second variant of the counting step keeping track of the number N of displacements of the presence detection device, and of the procedure prohibiting functioning in “fixed station” state.

Third Variant of the Counting Step to Count the Number of Displacements of the Presence Detection Device

According to a third variant, the presence detection device is connected to the PSTN to assure its locating. Counting step 131 to count the number N of displacements consists of counting the number of separate fixed line identifiers used by the presence detection device at the time of successive initialisations.

This assumes that at each initialisation of the presence detection device, the latter communicates its fixed line identifier (CLI for Calling Line Identifier) via the public switched telephone network (PSTN) to counting equipment. The counting equipment may for example be a first server, or the station. The latter receives the Calling Line Identifier directly or via a second server.

Optionally, at each initialisation of the presence detection device, the latter also communicates its device identifier (DI) to the station via their contacting or quasi-contacting. The station memorizes the association between the calling line identifier CLI and the device identifier (ID). A description follows of the functioning after a given initialisation of the presence detection device. At each contacting and/or quasi-contacting of the station with the presence detection device, the latter sends it device identifier (DI) to the station. The station verifies that it is identical to the device identifier (DI) previously memorized (and associated with the calling line identifier) at the time of the given initialisation. The station is only authorized to operate in “fixed station” state (or “logic fixed station”) if the two device identifiers (ID and ID′) are identical.

Fourth Variant of the Counting Step to Count the Displacements of the Presence Detection Device

It is assumed that at each initialisation of the presence detection device, the station detects and memorizes its position in the cell spaces it perceives. This position, for as long as no new initialisation is made, forms the “last memorized position of the station”.

When functioning after a given initialisation, the station, after each contacting and/or quasi-contacting with the presence detection device, detects its current position (in the cell space it perceives at this new instant). Then, the station calculates the distance between its current position and its last memorized position.

According to a fourth variant, counting step 131 to count the number N of displacements consists of counting the number of times when the calculated distance exceeds a maximum distance.

It is to be noted that, in the preceding distance calculation, the last memorized position may be replaced by the barycentre (or any other function) of at least some last positions previously detected and memorized.

Fifth Variant of the Counting Step to Count the Displacements of the Presence Detection Device

According to a fifth variant, counting step 131 to count the number N of displacements consists of incrementing by one unit the number N of displacements of the presence detection device if the accumulated number of separate cell identifiers perceived and/or used by the station during successive contacts and/or quasi-contacts exceeds a determined threshold.

This assumes that during successive contacts and/or quasi-contacts, between the presence detection device and the station, the latter detects the cell identifiers it perceives and/or uses for calls. The detection means of these cell identifiers are well known in themselves and shall not therefore be detailed here.

The threshold is a maximum number of separate identifiers. It may be downloaded into the presence detection device, by sending a message (SMS message of example) from the wireless communication network transiting via the station.

Sixth Variant of the Counting Step to Count the Displacements of the Presence Detection Device

According to a sixth variant, counting step 131 to count the number N of displacements consists of incrementing by one unit the number N of displacements of the presence detection device if the cell identifiers perceived and/or used by the station during successive contacts and/or quasi-contacts do not belong to a determined list of authorized cells.

This assumes that during successive contacts/quasi-contacts of the presence detecting device with the station, the latter detects the cell identifiers it perceives and/or uses for calls.

Partial Deactivation of the Station in “Fixed Station” State

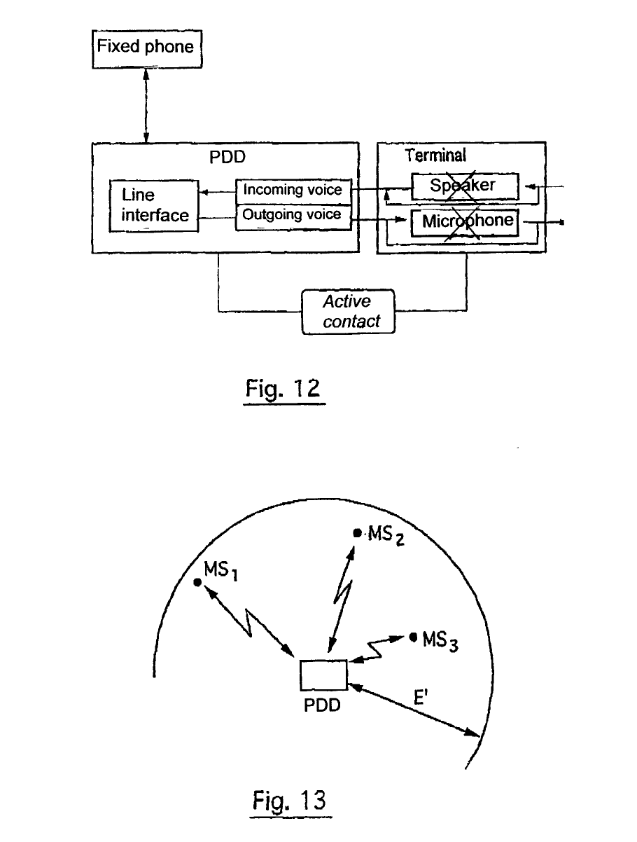

With reference to FIG. 12, another particular embodiment of the invention will now be described which also sets out to prevent displacement of the presence detection device.

During each contacting and/or quasi-contacting of the station with the presence detection device, one of more functionalities of the station are deactivated. The speaker, microphone and call reception means for example may be deactivated. In addition, via the presence detection device, use of the station is coupled with use of fixed equipment. This fixed equipment (a telephone set for example connected to the PSTN network) is connected to the presence detection device and in particular offers the functionality or functionalities deactivated on the station.

Therefore, during each contacting and/or quasi-contacting with the presence detection device, the user is compelled to use the fixed equipment and the user is therefore prevented from moving the presence detection device.

Authorization for Interrupted Connection of the Presence Detection Device

Optionally, a second time delay is applied in the presence detection device to allow the maintaining of its functioning during a second predetermined length of time after it has been disconnected from an electricity network and/or telephone network. In this way, interrupted connections are authorized whether voluntary (for example displacement of the presence detection device from one fixed location to another) or non-voluntary (a power cut for example) whose duration may be the same or less than the first time delay.

Since these interrupted connections of limited duration are authorized, they are not followed by re-setting of the presence detection device. Consequently, if the presence detection device is reconnected before the end of the second time delay, the first time delay described above (intended to prevent changeover to “fixed station” state) is exceptionally not triggered.

The length of the second time delay is approximately 15 minutes for example. Numerous other time values may evidently be considered while remaining within the scope of the present invention.

Presence Detection Device Common to Several Stations

Under one particular embodiment of the invention, illustrated in FIG. 13, the (or each) presence detection device PDD may be contacted and/or quasi-contacted, optionally in simultaneous manner, with several stations MS1, MS2, M33, . . . . Therefore one same presence detection device can be used to detect the presence of each of the stations inside the predetermined fixed location. In relation to its position, each station assumes one of the “fixed station” or “mobile station” states (and optionally “logic fixed station”) as explained above.

Two sub-variants of this particular embodiment are proposed.

In the first sub-variant, the predetermined fixed location is as described above. It is therefore a space of approximately 50 m, preferably less than 20 m (even a few centimeters). This enables several members of one same family for example to each use their station in multiple functioning states.

In the second sub-variant, the predetermined fixed location is more extensive and is formed of a space of several hundred meters (extent E¹ in FIG. 13). This fixed location of extent E¹ is for example a campus or factory, and the plurality of stations which operate in “fixed station” state when they are inside this space are for example owned by students or employees respectively. Numerous other applications of this second sub-variant may evidently be considered while remaining within the scope of the invention.

Downloading of a Temporary Network Identifier from the Presence Detection Device to the Station

Optionally, the present invention includes a downloading step, from the presence detection device to the station (preferably the SIM card) to download a temporary network identifier of the station and optionally at least one associated attribute. This downloading is made after contacting and/or quasi-contacting of the station with the presence detection device. In addition, it may be made in securitized manner if it is wished to reduce fraud risks.

Therefore, solely during the time of contacting and/or quasi-contacting of the station with the presence detection device can the station operate in “fixed station” state and with the downloaded temporary network identifier, and optionally with the associated attribute(s) also downloaded.

Consequently, the occupant of a predetermined fixed location (a hypermarket for example) may manage a plurality of temporary network identifiers, allocated to the customers present within this fixed location. This enables the occupant of the fixed location for example to take in charge, in full or in part, any calls established by stations present within this fixed location. For example while customers do their shopping in a supermarket, they may be offered communications by the manager of this supermarket (or by companies whose products it sells). It is assumed here that clients have a station able to place itself in contact and/or quasi-contact with the presence detection device located in the supermarket.

The attributes associated with the temporary network identifier, whether or not they are also downloaded, can be used for example to limit the number and/or duration and/or destination of calls which may be established using the temporary network identifier.

Method, System, Cellular Phone, Subscriber Identification Module and Presence Detection Device

On reading the above, it is easy to understand that the invention concerns a system and a method allowing multiple use of a cellular phone. Some characteristics of the system, which are not explicitly described above, may easily be deduced from the corresponding characteristics of the method.

It can also be understood that the invention also concerns the following parts taken separately: a cellular phone, a subscriber identification module (or SIM card) and a presence detection device. The specific means of each of these parts are described above, or may be easily deduced from the corresponding characteristics of the method.

Appendix: Example of a Limitation Mechanism for Displacements of the Presence Detection Device

In this appendix, by “immobilised” is meant the presence detection device (or any other electronic apparatus) whose displacement it is wished to restrict. By “immobiliser” is meant all the means enabling limitation of displacements by the immobilised device. The immobiliser is fixed to the immobilised device by any appropriate means. It is assumed that the immobilised device in particular comprises an electronic chip (or any other electronic component). According to one variant, the electronic chip described below is contained in the immobiliser. Limitation of displacements of the immobilised device is such that, if the immobiliser perceives a major displacement (whose extent is essentially parameterised) it memorizes an overstepping event. This event, when used by the immobilised device, leads to a halt in the service supplied by the immobilised device. Two embodiment options are described in detail below.

I—Option n°1: Displacement Detector

A) Functional Characteristics of the Immobiliser

It is small-size (1 to 20 cm). The assembly formed by the immobiliser and the electronic chip of the immobilised device is tamperproof. Any physical attack will cause blocking of the immobilised device. The immobiliser is a low-cost product; a few dollars. As illustrated in FIG. 14, the immobiliser 160 in particular comprises at least one displacement detector (or sensor) 161 connected to a memory 162. It performs the following operating functions:

detection of a displacement over more than X meters (for example X>100), it being possible to parameterise X.

independent functioning, that is to say permanent memorisation of threshold overstepping, independent from the electric supply to the immobilised device 163;

communication with the electronic chip 164 of the immobilised device;

re-setting of the memory 162 by means of a mechanical or electronic code. In theory this code is unknown to the user. It is renewed for each re-setting conforming either to an algorithm, or to a predefined list of values, the list being different for each immobilised device;

optional management of more than two set thresholds (e.g. S1: user alert and S2: blocking of immobilised device);

optional re-programming of the trigger threshold(s)

B) Functioning of the Immobiliser

The immobiliser conforms to the above-described functioning. Used for first time by the user, it is initialised by means of a mechanical or electronic code. It then records the displacement of the immobilised device. When a pre-programmed threshold is exceeded, the permanent memory 162 changes status. The information in memory 162 is accessible to the electronic chip 164 of the immobilised device. Re-setting of memory 162 status can be made either through the electronic chip 164 (electronic code) or via physical action by the user (mechanical code).

C) Memory—Electronic Chip Interface

C.1 Option 1: restricted

| Command | Parameters | Direction |
|---|---|---|
| Reset (Code) | [C1, . . ., Cn] | Chip → Memory |
| Event (Threshold) | [S1, T2] | Memory → Chip |
| Ack reset | | Memory → Chip |
| Ack event | | Chip → Memory |

Note:
S1: user warning; S2: Blocking of immobilised device

C.2 Option 2: complete

| Command | Parameters | Direction |
|---|---|---|
| Reset (Code) | [C1, . . ., Cn] | Chip → Memory |
| Set threshold (T1, T2) | in metres | Chip → Memory |
| Event (threshold) | [S1, S2] | Memory → Chip |
| Ack reset | | Memory → Chip |
| Ack set threshold | | Memory → Chip |
| Ack event | | Chip → Memory |

D) Implementation

The characteristics described above can be achieved for example using:

a one, two or three-axis accelerometer 161;

a memory 162, both writable since it can record threshold overstepping and permanent since it maintains its value with no electricity supply;

a dual integration analog or similar calculator, to obtain estimated displacement on the basis of an acceleration;

self-supply, produced for example by capturing kinetic energy.

The above method required a self-supplied device. Option 2 describes below concerns an immobilised device meeting the same purpose but battery-supplied.

II—Option n°2—Detector of Elementary Events

A) Characteristics of the Immobiliser

As illustrated in FIG. 15, the immobiliser 170 in particular comprises at least one displacement detector (or sensor) 171 connected to the electronic chip 174 of the immobilised device 173, which itself is connected to a memory 172. According to one variant, an electronic chip specific to the immobiliser is used. The immobiliser 170 provides the following functionalities:

detection of elementary events which, after calculation, allows measurement of distance covered

communication of all elementary events to the electronic chip 174;

permanent supply to the electronic chip 174 via an electricity source of removable battery or battery pack type. Even when disconnected from the mains, the immobilised device will record elementary events;

resetting of the electronic chip's memory by means of a mechanical or electronic code. In theory the code is unknown to the user. A different code is transmitted at each resetting. The production of codes conforms either to an algorithm, or to a list of predefined values, the list being different for each immobilised device;

optional management of more than two trigger thresholds (e.g. S1 user alert; S2: blocking of the immobilised device);

optional re-programming of the trigger threshold(s)

B)Functioning of the Immobiliser

The immobiliser conforms to the functioning described below. When used for the first time by the user, the memory of the electronic chip 174 is initialised using a mechanical or electronic code. The immobiliser detects elementary events and communicates these to the electronic chip 174. The electronic chip 174 records (in memory 172) and processes elementary events. When one of the pre-programmed thresholds is overstepped, the electronic chip 174 changes status and either sends an alert or blocks the immobilised device. Status resetting of the memory 172 is possible either via the electronic chip (electronic code) or via physical action by the user on a switch for example with 0-7 values (mechanical code). Total loss of supply to the electronic chip causes blocking of the immobilised device.

C) A Permanent Source of Electricity

The internal, permanent electricity source enables the electronic chip to memorize elementary events when the immobilised device is disconnected from the mains. Two options are possible:

integration of a non-accessible, rechargeable battery pack;

integration of a maximum lifetime battery with difficult access.

C.1) Non-Accessible Rechargeable Battery Pack

This type of battery has the following characteristics:

capacity to recharge when the immobilised device is connected to the mains;

tamperproof and sealed within the device formed by the electronic chip and immobiliser;

operating time of more than one month;

lifetime greater than 3 years.

C.2) Battery with Difficult Access and Maximum Lifetime

This type of battery has the following characteristics:

maximum lifetime

difficult access to avoid manipulation errors

This solution carries a fraud risk. If the battery is removed, the immobiliser can no longer record events and therefore can no longer immobilise the immobilised device. To overcome this risk, the electronic chip is blocked whenever the supply to the electronic chip is interrupted. FIG. 16 shows a diagram of the state of the immobilised device when a removable battery is used.

D) Implementation

The above-described characteristics can be achieved for example by means of:

a one, two or three-axis accelerometer,

a memory 172, both writable as it allows the recording of threshold overstepping and permanent as it maintains its value when there is no electricity supply;

a dual integration analogue or equivalent calculation made by the electronic chip 174 to obtain an estimate of displacement on the basis of an acceleration;

a removable battery or battery pack (not shown) supplying the electronic chip.

1. Method enabling multiple use of a cellular phone, also called a station (MS) of the type included in a wireless communication system, characterized in that said station may assume at least the two following operating states, each one defined by at least one distinct state parameter:
a so-called “mobile station” state, associated with a situation of geographical mobility of said station;
a so-called “fixed station” state associated with a situation of geographical fixity of said station inside a predetermined fixed location (FL), closely delimited in space;
and in that said method comprises:
at least one state switching step of said station, either automatic and/or on user command, in relation to the geographical position of said station;
at least one comparison step to compare the position of said station relative to the said predetermined fixed location, so as to trigger or validate said at least one state switching step if said station effectively moves from inside to outside said predetermined fixed location, or conversely.

2. Method according to claim 1, characterized in that said predetermined fixed location (FL) is formed of a space of approximately 50 m, preferably less than 20 m.

3. Method according to either of claims 1 and 2, characterized in that said predetermined fixed location belongs to the group comprising:
precise geographical positions;
private homes;
workplaces;
temporary places of presence;
secondary homes;
retail outlets.

4. Method according to any of claims 1 to 3, characterized in that said comparison step comparing the position of said station relative to said predetermined fixed location comprises an operation to detect the presence of said station inside said predetermined fixed location by the contacting and/or quasi-contacting of said station with at least one presence detection device (PDD) of said station (MS) inside said predetermined fixed location (FL), and in that the geographical position (C) and extent (E) of said predetermined fixed location (FL) are respectively defined by:
the geographical position of said at least one presence detection device, and
the range of said contact and/or quasi-contact between said at least one presence detection device and said station.

5. Method according to any of claims 1 to 3, characterized in that said comparison step comparing the position of said station relative to said predetermined fixed location comprises an operation to detect the presence of said station inside said predetermined fixed location by calculations based on locating data derived from said wireless communication system and/or an external locating system.

6. Method according to claims 4 and 5, characterized in that said operation detecting the presence of said station inside said predetermined fixed location combines firstly said contacting and/or quasi-contacting of said station with said presence detection device, and secondly said calculations based on locating data derived from said wireless communication system and/or an external locating system.

7. Method according to any of claims 1 to 6, characterized in that said two distinct state parameters each defining one of said operating states are network identifiers of said station, implicitly forming state transmission parameters towards a wireless communication network of said wireless communication system.

8. Method according to any of claims 1 to 6, characterized in that said two distinct state parameters, each defining one of said operating states, are state parameters internal to said station and therefore are not network identifiers of said station, and in that said station transmits state transmission parameters to a wireless communication network of said wireless communication system such that said wireless communication network knows the operating state of said station.

9. Method according to either of claims 7 and 8, characterized in that said network identifiers of said station belong to the group comprising:
IMSIs
mobile numbers (MSISDN);
fixed numbers;
“inoperative” state parameters.

10. Method according to any of claims 1 to 9, characterized in that said two distinct state parameters, each one defining one of said operating states, form a pair belonging to the group comprising:
two distinct IMSIs
two distinct mobile numbers;
one fixed number and one mobile number
two distinct fixed numbers;
two state parameters internal to said station.

11. Method according to any of claims 1 to 9, said station comprising a terminal and a subscriber identification module, characterized in that to implement said state switching step at least in part, said terminal and/or said subscriber identification module comprises a selection functionality to select one of said two distinct state parameters, so as to define a current operating state among said “mobile station” and “fixed station” states.

12. Method according to any of claims 1 to 11, characterized in that said station comprises a forwarding functionality for incoming calls, consisting of forwarding to the station in its current functioning state any incoming calls intended for said station when it is in one of said operating states which is not said current operating state.

13. Method according to any of claims 1 to 12, characterized in that each of said “fixed station” and “mobile station” states, in addition to said at least one distinct state parameter, has at least one own attribute.

14. Method according to any of claims 1 to 13, characterized in that said “fixed station” and “mobile station” states have at least one common attribute.

15. Method according to either of claims 13 and 14, characterized in that said at least one own attribute and said at least one common attribute belong to the group comprising:
invoicing modes for incoming calls;
invoicing modes for outgoing calls;
telephone numbers;
roaming rights;
rights to international calls;
added value functionalities and/or services (directory, WAP content services, etc.);
Internet access functionalities and/or services via the wireless communication network to which the station is linked;
functionalities and/or services for access to data and/or fax services;
voice mail functionalities and/or services;
forwarding functionalities and/or services;
address book functionalities and/or services;
directory functionalities and/or services.

16. Method according to any of claims 1 to 15, characterized in that said station does not change directly from the “fixed station” state to the “mobile station” state, but passes through an intermediate state called “logic fixed station” state in which said station continues to operate until the occurrence of at least one predetermined event, as in said “fixed station” state, even though the conditions for switching from the “fixed station” state to the “mobile station” state have been verified.

17. Method according to claim 16 and any of claims 4 to 6, characterized in that said at least one predetermined event is the endpoint of an armed time delay:
when contact and/or quasi-contact between the station and the presence detection device ceases; and/or
when there is a change in or loss of said locating data derived from said wireless communication system and/or from said external locating system.

18. Method according to claim 17, characterized in that said time delay has an initial period which is extended by the duration of any communications established or received by said station during said initial period.

19. Method according to claim 16, characterized in that said at least one predetermined event is the occurrence of a network event.

20. Method according to claim 19, characterized in that said network event belongs to the group comprising:
periodic location updates;
handovers;
changes in attachment cell;
changes in relative position;
link loss with one or more neighbouring cells

21. Method according to claim 16, characterized in that said at least one predetermined event is voluntary action by the user.

22. Method according to claims 4 and 16, characterized in that said event is a change in the relative position of said station, estimated differentially by comparing the current position of said station and its last position(s) in contact and/or quasi-contact with said presence detection device.

23. Method according to claim 22, characterized in that said comparison between the current position of the station and the last position(s) in contact and/or quasi-contact with said presence detection device is estimated by calculating the position P of said station in the space of cells C1, C2, . . . , CN perceived by said station, the calculation of said position P being expressed as:
P=λC1+μC2+ . . . +νCN
in which the weights λ, μ, ν represent either the intensity of a signal received by said station, or a function of said intensity, or a time shift in signal propagation to said station, or a function of said time shift, or a combination function of at least two of these representation methods.

24. Method according to claim 22, characterized in that said comparison between the current position of the station and the last position(s) in contact and/or quasi-contact with said presence detection device is estimated by determining the displacement of said station by means of a device integrated in said station, and preferably in an identification module contained in said station, said integrated device comprising:
a position and/or displacement and/or speed and/or acceleration sensor and/or at least one inclinometer,
a calculation and memorisation unit, separate or not from the standard calculation and memorisation unit of the identification module, and
if there are two separate calculation and memorisation units, a communication channel between said separate calculation and memorisation units.

25. Method according to any of claims 1 to 24, characterized in that said “mobile station” state is deactivated and replaced by an “inoperative station” state so that said station may assume either said “fixed station” state or said “inoperative station” state.

26. Method according to claims 10 and 25, characterized in that said group of pairs of separate state parameters also comprises the following pairs:
a mobile number and an “inoperative” state parameter
a fixed number and an “inoperative” state parameter
an IMSI and an “inoperative” state parameter.

27. Method according to any of claims 4 to 26, said station comprising a terminal and a subscriber identification module, characterized in that said contacting and/or quasi-contacting of said station with said presence detection device is made by placing in contact and/or quasi-contact said subscriber identification module with said presence detection device, so as to enable a dialogue between said presence detection device, said subscriber identification module and said terminal.

28. Method according to claim 27, characterized in that said subscriber identification module and said presence detection device are placed in non-physical contact, so-called quasi-contact.

29. Method according to claim 28, said subscriber identification module conventionally comprising a first chip, characterized in that said subscriber identification module also comprises a second chip containing means for implementing said quasi-contact, and in that said first and second chips may be simultaneously and/or alternately active and dialogue together, and in that said first and second chips are contained on one same substrate or contained on different substrates but connected by a communication channel.

30. Method according to claim 29, characterized in that said first and second chips are supplied by said terminal.

31. Method according to claim 29, characterized in that said second chip draws its energy from a signal derived from said presence detection device.

32. Method according to claim 28, said subscriber identification module conventionally comprising a chip, characterized in that said chip contains means for implementing said quasi-contact.

33. Method according to any of claims 27 to 32, characterized in that said dialogue between said terminal, said subscriber identification module and said presence detection device makes it possible to perform:
said operation detecting the presence of said station inside said predetermined fixed location;
and in addition at least one additional function.

34. Method according to claim 33, characterized in that said at least one additional function belongs to the group comprising:
identification functions of said subscriber identification module by said presence detection device, and/or vice-versa;
authentication functions of said subscriber identification module by said presence detection device, and/or vice-versa;
data exchange functions, irrespective of subject, between:
firstly said terminal and/or said subscriber identification module and/or at least one item of equipment or computer application positioned on and/or upstream from the wireless communication network to which said station has access;
and, secondly, said presence detection device and/or at least one item of equipment or at least one computer application positioned downstream from said presence detection device.

35. Method according to any of claims 4 to 34, characterized in that said contact belongs to the group comprising:
electric contacts;
electronic contacts;
mechanical contacts;
a combination of at least two types of above-mentioned contacts.

36. Method according to any of claims 4 to 34, characterized in that said quasi-contact belongs to the group comprising:
short range quasi-contacts, from approximately 0.1 cm to 2 m, and medium range, from approximately 0.1 cm to 50 m, by electromagnetic waves of-any type;
short range quasi-contacts, of approximately 0.5 cm to 2 m, and medium range, of approximately 0.1 cm to 50 m, by sound or ultrasound waves.

37. Method according to any of claims 4 to 34, characterized in that said quasi-contacting is made according to “Contactless” technique methods based on adaptation of norms ISO 14443 and 15693 enabling short range quasi-contact by electromagnetic waves.

38. Method according to any of claims 4 to 34, characterized in that said quasi-contacting is achieved using the technique of active and/or passive tags enabling short and/or medium range quasi-contact by electromagnetic waves.

39. Method according to any of claims 4 to 34, characterized in that said quasi-contacting is achieved using a communication technique via infrared enabling medium range quasi-contact by electromagnetic waves.

40. Method according to any of claims 4 to 34, characterized in that said quasi-contacting is achieved using a communications technique of “Bluetooth” type, enabling medium range quasi-contact by electromagnetic waves.

41. Method according to claims 27 and 40, characterized in that said communications of “Bluetooth” type enabling said quasi-contact are implemented by exchange of asynchronous messages between two applications, one performed on the subscriber identification module and the other on the presence detection device, said asynchronous messages being triggered at the initiative of either one of said applications,
in that the application performed by the subscriber identification module is based on two data messages, send and receive respectively, towards the presence detection device,
and in that the application performed by the presence detection device is based on two data messages, send and receive respectively, towards the subscriber identification module.

42. Method according to any of claims 4 to 34, characterized in that said quasi-contacting is made using the electromagnetic communications technique in the 400 MHz or 900 MHZ bands, enabling medium range quasi-contact by electromagnetic waves.

43. Method according to any of claims 4 to 34, characterized in that the presence detection device has a simplified base station emulating function, and is associated with a geographical pseudo-cell having an identifier,
and in that said quasi-contacting is made when the station, preferably the subscriber identification module, recognizes said identifier of the geographical pseudo-cell.

44. Method according to any of claims 4 to 34, characterized in that said quasi-contacting is made using the communications technique via wireless local networks, enabling medium range quasi-contact by electromagnetic waves.

45. Method according to any of claims 4 to 44, characterized in that it comprises an irreversible fixing step of said presence detection device on a non-removable building support, so as to prohibit any displacement of said presence detection device.

46. Method according to any of claims 4 to 44, characterized in that it comprises a limitation step limiting the displacement of said presence detection device, itself comprising the following steps:
initialisation of said presence detection device;
counting the number N of displacements of said presence detection device by a user, from said predetermined fixed location to another predetermined fixed location;
when said number N of displacements becomes greater than a maximum number of displacements Nₘₐₓ, predetermined or defined in adaptive manner, where Nₘₐₓ≧0, triggering of a procedure prohibiting operation in said “fixed station” state and/or sending of an alert to a management system and/or informing the user of said overstepping.

47. Method according to claim 46, characterized in that said prohibited operation of the station in “fixed station” state may be lifted by at least one of the operations belonging to the group comprising:
entry of a re-enabling code by the user into said station and/or said presence detection device;
sending of a message, by the wireless communication network to which the station has access, to the station and/or the presence detection device via the station.

48 Method according to claim 47, characterized in that said re-enabling code varies for each re-enabling and conforms either to a predefined algorithm, or to a predefined list of re-enabling code values, said algorithm and/or said list being different for each presence detection device.

49. Method according to any of claims 46 to 48, characterized in that said procedure prohibiting operation in said “fixed station” state consists of applying a first time delay, interdicting changeover of the station to the “fixed station” state for a first predetermined time interval after it has been detected that the number N of displacements has exceeded said maximum number Nₘₐₓ of displacements.

50. Method according to claim 49, characterized in that the initial duration of the first time delay is approximately 24 hours.

51. Method according to any of claims 46 to 50, characterized in that said initialisations are produced:
periodic fashion,
and/or on receipt of a message from the wireless communication network to which the station has access;
and/or according to a predetermined initialisation strategy;
and/or after each (re)connection of said presence detection device to the electricity network and/or to the public switched telephone network.

52. Method according to any of claims 46 to 51, characterized in that said counting step to count the number N of displacements, after initial connection and associated initialisation, consists of counting the number of reconnections of said presence detection device to an electricity network and/or a telephone network.

53. Method according to any of claims 46 to 51, characterized in that, when functioning after a given initialisation of said presence detection device, said presence detection device estimates the distance it has covered since said given initialisation,
and in that said counting step to count the number N of displacements of said presence detection device consists of counting the number of times said estimated distance exceeds a maximum distance.

54. Method according to claim 53, characterized in that said estimate by the presence detection device of the distance it has covered, is made by means of at least one displacement and/or speed and/or acceleration sensor and/or at least one inclinometer.

55. Method according to claim 54, characterized in that said estimate by the presence detection device of the distance it has covered is calculated by an elementary event function generated by said at least one displacement and/or speed and/or acceleration sensor and/or at least one inclinometer,
and in that the number of displacements is incremented by one unit if the value of said elementary event function exceeds a determined threshold.

56. Method according to claim 55, characterized in that said threshold is downloaded by a message sent by the wireless communication network, to which the station has access, towards the presence detection device, via the station.

57. Method according to any of claims 46 to 51, characterized in that said presence detection device is connected to the switched telephone network and in that at each resetting of said presence detection device, said presence detection device communicates its fixed line identifier via the switched telephone network, either to a first server, or to said station directly or via a second server,
and in that said counting step to count the number N of displacements of said presence detection device consists of counting the number of distinct fixed line identifiers used by said presence detection device at the time of successive initialisations.

58. Method according to claim 57, characterized in that, at each initialisation of said presence detection device, said presence detection device also communicates its device identifier to said station, via said contact and/or quasi-contact, and said station memorizes the association between said fixed line identifier and said device identifier,
and in that, when operating after a given initialisation of said presence detection device, the station receives said device identifier from said presence detection device at each contacting and/or quasi-contacting, and verifies that it is identical to the memorised device identifier and associated with the fixed line identifier at the time of said given initialisation.

59. Method according to any of claims 46 to 51, characterized in that, at each initialisation of said presence detection device, said station locates and memorizes its position in the space of the cells it perceives,
and in that, when functioning, after each contacting and/or quasi-contacting with the said presence detection device, the station calculates the distance between its current position and either its last memorized position, or the barycentre or another function of at least some last positions previously detected and memorized,
and in that said counting step to count the number N of displacements of said presence detection device, consists of counting the number of times said distance exceeds a maximum distance.

60. Method according to any of claims 46 to 51, characterized in that, during successive contacts and/or quasi-contacts of said presence detection device with said station, said station detects the identifiers of the cells perceived and/or used by the station for calls,
and in that said counting step consists of incrementing by one unit the number N of displacements of said presence detection device if the accumulated number of separate identifiers of cells perceived and/or used by the station during said contacts and/or quasi-contacts exceeds a determined threshold.

61. Method according to claim 60, characterized in that said threshold is downloaded by a message sent by the wireless communication network, to which the station has access, towards the presence detection device, via the station.

62. Method according to any of claims 46 to 51, characterized in that during successive contacts and/or quasi-contacts of said presence detection device with said station, said station detects the identifiers of the cells perceived and/or used by the station for calls,
and in that said counting step consists of incrementing by one unit the number N of displacements of said presence detection device if the identifiers of the cells perceived and/or used by the station during said successive contacts and/or quasi-contacts do not belong to a determined list of authorized cells.

63. Method according to any of claims 4 to 62, characterized in that, after said contacting and/or quasi-contacting of said station with said presence detection device, said method comprises the following steps:
deactivation of at least one functionality of said station, and
coupling, via said presence detection device, the use of said station with the use of fixed equipment offering at least said at least one deactivated functionality
so that in said “fixed station” state, said station may only be used with said fixed equipment.

64. Method according to claim 63, characterized in that said at least one deactivated functionality of the station belongs to the group comprising: the speaker, microphone and call reception means.

65. Method according to any of claims 4 to 64, characterized in that a second time delay enables maintained functioning of said presence detection device for a second predetermined time interval after it has been disconnected from an electricity network and/or telephone network, so as to authorize interrupted connections of a duration equivalent to or less than said second time period.

66. Method according to claim 65, characterized in that said second duration of said second time delay is approximately 15 minutes.

67. Method according to either or claims 49 and 65, characterized in that at least one of said first and second time periods is dynamically adaptable in relation to at least one predetermined adaptation parameter.

68. Method according to either of claims 49 and 65, characterized in that said first time delay and/or said second time delay is (are) implemented in the presence detection device.

69. Method according to any of claims 4 to 68, characterized in that said presence detection device also assures a charger base function, with which to recharge a battery contained in said station, when said station is contacted and/or quasi-contacted with said presence detection device.

70. Method according to any of claims 4 to 69, characterized in that said at least one presence detection device may be placed in contact and/or quasi-contact, optionally in simultaneous manner, with at least two stations, to allow presence detection of each of said at least two stations inside said predetermined fixed location.

71. Method according to claim 70, insofar as it is not attached to claim 2, characterized in that said predetermined fixed location is made up of a space of a few hundred meters.

72. Method according to any of claims 4 to 71, characterized in that said at least one presence detection device and said station use unilateral or mutual identification and/or authentication mechanisms.

73. Method according to any of claims 4 to 72, characterized in that after contacting and/or quasi-contacting the station with the presence detection device, said method comprises a downloading step from the presence detection device to the station, in securitized manner, to download a temporary network identifier of the station and optionally at least one associated attribute, so that the station operates solely during the time of said contacting and/or quasi-contacting in said “fixed station” state and with the downloaded temporary network identifier, and optionally said at least one associated attribute.

74. Method according to any of claims 4 to 73, characterized in that, during their contacting and/or quasi-contacting, the station and the presence detection device together form a relay, for at least one item of equipment having a telephone function and connected to said presence detection device, towards the wireless communication network to which the station is linked.

75. System enabling multiple use of a cellular phone, also called a station, characterized in that said station may assume at least the two following operating states, each one defining at least one distinct state parameter:
a so-called “mobile station” state, associated with a situation of geographical mobility of the station;
a so-called “fixed station” state, associated with a situation of geographical fixity of said station inside a predetermined fixed location, closely delimited in space;
and in that it comprises:
station state switching means, either automatic and/or on user command, in relation to its geographical position;
comparison means to compare the position of said station relative to said predetermined fixed location, so as to trigger or validate, in real or delayed time, each station state changeover made by said station state switching means if said station effectively moves from inside to outside said predetermined fixed location, or conversely.

76. System according to claim 75, characterized in that it also comprises means enabling application of the method according to any of claims 1 to 63quater.

77. Cellular phone, also called station, of the type included in a wireless communication system, characterized in that said station may assume at least the two following operating states, each one defining at least one distinct state parameter:
a so-called “mobile station” state, associated with a situation of geographical mobility of the station;
a so-called “fixed station” state, associated with a situation of geographical fixity of said station inside a predetermined fixed location, closely delimited in space;
and in that said station comprises:
state switching means for said station, automatic and/or on user command, in relation to its geographical position;
comparison means to compare the position of said station relative to a predetermined fixed location so as to trigger or validate, in real or delayed time, each state changeover made by said switching means if said station effectively moves from inside to outside said predetermined fixed location, or conversely.

78. Cellular phone, also called a station, according to claim 77, characterized in that said station also comprises means enabling implementation of the method according to any of claims 1 to 74.

79. Subscriber identification module, of the type intended to cooperate with a terminal within a cellular phone, also called a station, characterized in that said station may assume at least the two following operating states, each one defining at least one distinct state parameter:
a so-called “mobile station” state, associated with a situation of geographical mobility of the station;
a so-called “fixed station” state associated with a situation of geographical fixity of said station inside a predetermined fixed location, closely delimited in space;
and in that said subscriber identification module comprises:
state switching means for said station, automatic and/or on user command, in relation to its geographical position;
comparison means to compare the position of said station relative to said predetermined fixed location, so as to trigger or validate, in real or delayed time, each state changeover made by said switching means, if said station effectively moves from inside to outside said predetermined fixed location, or conversely.

80. Subscriber identification module according to claim 79, characterized in that it also comprises means enabling implementation of the method according to any of claims 1 to 74.

81. Presence detection device, characterized in that it comprises means for contacting and/or quasi-contacting with a cellular phone, also called a station, so as to enable the conducting of a presence detecting operation of said station inside a predetermined fixed location,
the geographical position and the extent of said predetermined fixed location being respectively defined by:
the geographical position of said at least one presence detection device, and
the range of said contact and/or quasi-contact between said at least one presence detection device and said station.

82. Presence detection device according to claim 81, characterized in that it also comprises means enabling implementation of the method according to any of claims 4 and 6 to 74.
